(19) United States
(12) Patent Application Publication
(10) Pub. No.: US 2025/0111394 A1
(43) Pub. Date: Apr. 3, 2025

(54) PERFORMING SENTIMENT ANALYSIS FOR SURVEY RESPONSES

(71) Applicant: Content Square SAS, Paris (FR)

(72) Inventors: Antonis Rousounelos, Paris (FR); Bjöern Meier, Paris (FR); Jess Ashworth, Paris (FR); Nikos Michas, Paris (FR); Heeryung Shin, Paris (FR); Romina Martin, Paris (FR); Jacobo de Vera, Paris (FR); Dan Trott, Paris (FR)

(21) Appl. No.: 18/902,487

(22) Filed: Sep. 30, 2024

(30) Foreign Application Priority Data
Sep. 29, 2023 (GR) 20230100791

(51) Int. Cl. G06Q 30/0203

(52) U.S. Cl. CPC G06Q 30/0203

(57) ABSTRACT

Aspects of the present disclosure involve a system comprising a computer-readable storage medium storing a program and method for performing sentiment analysis for survey responses. The program and method provide for receiving, from a first device, an indication of user input selecting to perform sentiment analysis with respect to survey response data; accessing, in response to receiving the user input, the survey response data from storage, the survey response data including a respective question and response pair for each of plural questions included within a survey provided to at least one second device; determining, using a large language model, a sentiment classification for the respective question and response pair for each of the plural questions, the sentiment classification being one of positive sentiment, negative sentiment or neutral sentiment; and providing, based on determining the sentiment classification for each of the plural questions, display of sentiment metrics on the first device.

### TECHNICAL FIELD

The present disclosure relates generally to webpage analysis, including performing sentiment analysis for survey responses.

### BACKGROUND

Web analysis solutions provide for the collection and analysis of website data. Such solutions may provide for receiving user feedback with respect to webpage visits.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some nonlimiting examples are illustrated in the figures of the accompanying drawings in which:

FIG. 1 is a diagrammatic representation of a networked environment in which the present disclosure may be deployed, in accordance with some examples.

FIG. 2 is a diagrammatic representation of an experience analytics system, in accordance with some examples, that has both client-side and server-side functionality.

FIG. 3 is a diagrammatic representation of a data structure as maintained in a database, in accordance with some examples.

FIG. 4 illustrates an architecture for performing sentiment analysis for survey responses, in accordance with some examples.

FIG. 5 illustrates a user interface flow for editing sentiment tags with respect to performing sentiment analysis for survey responses, in accordance with some examples.

FIG. 6 illustrates a user interface flow for applying filters with respect to performing sentiment analysis for survey responses, in accordance with some examples.

FIG. 7 illustrates a user interface flow for enabling sentiment analysis for survey responses, in accordance with some examples.

FIG. 8 illustrates a user interface flow for viewing results with respect to performing sentiment analysis for survey responses, in accordance with some examples.

FIGS. 9A-9O illustrate various user interfaces related to editing sentiment tags per FIG. 5, in accordance with some examples.

FIGS. 10A-10L illustrate various user interfaces related to applying filters per FIG. 6, in accordance with some examples.

FIGS. 11A-11M illustrate various user interfaces related the enabling on sentiment analysis in FIG. 7, in accordance with some examples.

FIGS. 12A-12K illustrate various user interfaces related to the results view of FIG. 8, in accordance with some examples.

FIG. 13 is a flowchart illustrating a process for performing sentiment analysis for survey responses, in accordance with some examples.

FIG. 14 is a diagrammatic representation of a machine in the form of a computer system within which a set of instructions may be executed for causing the machine to perform any one or more of the methodologies discussed herein, in accordance with some examples.

FIG. 15 is a block diagram showing a software architecture within which examples may be implemented.

### DETAILED DESCRIPTION

Web analysis solutions provide for the collection and analysis of website data. Example web analysis tools include the tracking and recording of session events corresponding to user interactions, automated website zone identification, session replay, statistical analysis of collected data, user-provided webpage/website feedback and the like.

The disclosed embodiments as described herein provide an experience analytics system for performing sentiment analysis for survey responses. The experience analytics system receives, from a first device (e.g., a member client), an indication of user input selecting to perform sentiment analysis with respect to survey response data. The experience analytics system accesses, in response to receiving the user input, the survey response data from storage, the survey response data including a respective question and response pair for each of plural questions included within a survey provided to at least one second device. The experience analytics system determines, using a large language model, a sentiment classification for the respective question and response pair for each of the plural questions, the sentiment classification being one of positive sentiment, negative sentiment or neutral sentiment. The experience analytics system provides, based on determining the sentiment classification for each of the plural questions, display of sentiment metrics on the first device.

By virtue of performing sentiment analysis in this manner, the system provides for facilitated user engagement with respect to reviewing user satisfaction. For example, the system reduces manual aspects (e.g., user input for creating a report/metrics of user satisfaction) associated with conventional techniques for sentiment analysis. In addition, the system facilitates the user's ability to quickly understand the sentiment (e.g., via positive, negative and neutral tags) associated with surveys. Thus, the system facilitates sentiment analysis, thereby saving time for end users, and reducing computational resources/processing power.

### Networked Computing Environment

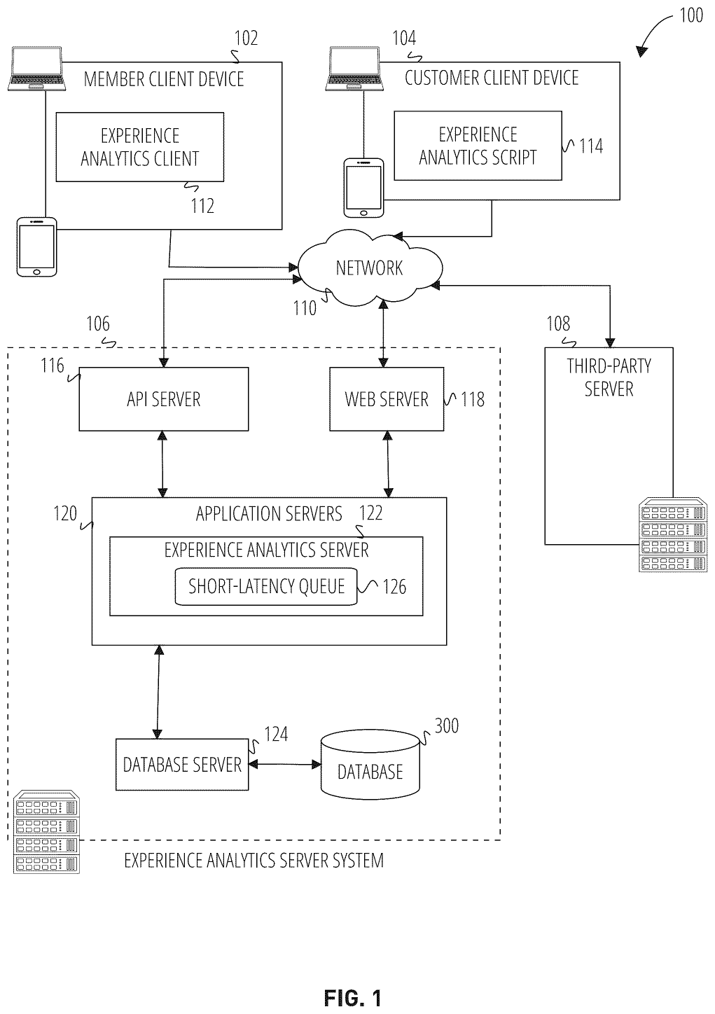

FIG. 1 is a block diagram showing an example experience analytics system 100 that analyzes and quantifies the user experience of users navigating a client's website, mobile websites, and applications. The experience analytics system 100 can include multiple instances of a member client device 102, multiple instances of a customer client device 104, and multiple instances of a third-party server 108.

The member client device 102 is associated with a client of the experience analytics system 100, where the client that has a website hosted on the client's third-party server 108. An agent of the client (e.g., a web administrator, an employee, an operator, etc.) can be the user of the member client device 102.

Each of the member client devices 102 hosts a number of applications, including an experience analytics client 112. Each experience analytics client 112 is communicatively coupled with an experience analytics server system 106 and third-party servers 108 via a network 110 (e.g., the Internet). An experience analytics client 112 can also communicate with locally-hosted applications using Applications Program Interfaces (APIs).

The member client devices 102 and the customer client devices 104 can also host a number of applications including Internet browsing applications (e.g., Chrome, Safari, etc.). The experience analytics client 112 can also be implemented as a platform that is accessed by the member client device 102 via an Internet browsing application or implemented as an extension on the Internet browsing application.

Users of the customer client device 104 can access client's websites that are hosted on the third-party servers 108 via the network 110 using the Internet browsing applications. For example, the users of the customer client device 104 can navigate to a client's online retail website to purchase goods or services from the website.

The third-party server 108 may include data relating to websites, data relating to webpages, other, like, data, and any combination thereof. The third-party server 108 may be a local web source(s), remote web source(s), or any combination thereof, including a cloud-based network(s), distributed network(s), and the like. Examples of the third-party server 108 include, but are not limited to, repositories of webpage information, repositories of webpage element or zone information, servers configured to provide “live” webpages, other, like, sources, and any combination thereof.

While a user of the customer client device 104 is navigating a client's website on an Internet browsing application, the Internet browsing application on the customer client device 104 can also execute a client-side script (e.g., JavaScript (.*js)) such as an experience analytics script 114. In one example, the experience analytics script 114 is hosted on the third-party server 108 with the client's website and processed by the Internet browsing application on the customer client device 104. The experience analytics script 114 can incorporate a scripting language (e.g., a .*js file or a .json file).

In certain examples, a client's native application (e.g., ANDROID™ or IOS™ Application) is downloaded on the customer client device 104. In this example, the client's native application including the experience analytics script 114 is programmed in JavaScript leveraging a Software Development Kit (SDK) provided by the experience analytics server system 106. The SDK includes Application Programming Interfaces (APIs) with functions that can be called or invoked by the client's native application.

In one or more embodiments, the experience analytics script 114 is configured to collect activity relating to a client's interaction with the third-party server 108 content through a webpage displayed on the customer client device 104. In one example, the experience analytics script 114 records data including the changes in the interface of the webpage being displayed on the customer client device 104, the elements on the webpage being displayed or visible on the interface of the customer client device 104, the text inputs by the user into the webpage, a movement of a mouse (or touchpad or touch screen) cursor, user scrolls, and mouse (or touchpad or touch screen) clicks on the interface of the webpage. In addition, and with proper user permissions, the experience analytics script 114 may be configured to collect activity data features including, customer client device 104 type, website/application type, customer client device 104 geolocation, customer client device 104 internet protocol (IP) address, uniform resource locators (URLs) accessed by the customer client device 104, customer client device 104 screen resolution, and/or referrer URLs.

The experience analytics script 114 transmits the data to the experience analytics server system 106 via the network 110. In another example, the experience analytics script 114 transmits the data to the third-party server 108 and the data can be transmitted from the third-party server 108 to the experience analytics server system 106 via the network 110. As such, the experience analytics script 114 is configured to collect activity relating to a client's interaction with web server content (e.g., content from the third-party server 108) through a webpage displayed on the customer client device 104.

In one or more embodiments, the experience analytics script 114 may be included within the source code of a webpage, such as the hypertext markup language (HTML) code underlying such a webpage, where such source code is hosted by the third-party server 108 (e.g., web server). Where a user of the customer client device 104 connects to the third-party server 108 and requests to visit a given webpage, the underlying code for the webpage is downloaded to the customer client device 104 and rendered thereupon, including the experience analytics script 114, providing for user interaction with the webpage, as well as for data collection by the experience analytics script 114.

In one or more embodiments, the member client device 102 includes an experience analytics client 112. The experience analytics client 112 is a platform, program, service, or the like, configured to provide help agents, and the like, with the ability to view details of a live session. For example, the experience analytics client 112 is configured to provide user interfaces to display one or more features of a live session, including, without limitation, live session events, historical replay data, and the like, as well as any combination thereof. The experience analytics client 112 may be configured to provide a help agent with a unique per-session view, the unique per-session view corresponding to a single user's current session. The experience analytics client 112 may be configured to provide the unique view upon the help agent's activation of a unique link (e.g., a live session link), where such a unique link may be sent to the member client device 102 upon a user's interaction with a “live support” or similar button or feature, as may be included in a webpage which a user is visiting on the customer client device 104.

The experience analytics client 112 may be further configured to identify, based on the contents of the unique link, one or more relevant live replay data features including, without limitation, live session events, historical recorded events, and the like, and to collect, receive, or otherwise access such data features. Specifically, the experience analytics client 112 may be configured to access live session events by opening a connection to a short-latency queue (SLQ) 126.

In addition, the experience analytics client 112 may be configured to collect or receive data relevant to one or more previous sessions including, as examples and without limitation, session replays, session replay analytics, and the like. The experience analytics client 112 may be configured to provide for collection, receipt, or the like, of such data, as may be relevant to such previous sessions, from one or more sources including, without limitation, the database 300, and the like, as well as any combination thereof.

Following collection, receipt, or the like, of live and historical session data, the experience analytics client 112 provides for displaying user interface(s) with one or more of such data features to a help agent, providing for agent review of current and historical session data. Such presentation, through the member client device 102, provides for short-term view of session data combined with long-term persistent view of session data. In this regard, data exchanged between the experience analytics client 112 and the experience analytics server system 106 may include functions (e.g., commands to invoke functions) as well as payload data (e.g., website data, texts reporting errors, insights, merchandising information, adaptability information, images, graphs providing visualizations of experience analytics, session replay videos, zoning and overlays to be applied on the website, etc.).

The experience analytics server system 106 supports various services and operations that are provided to the experience analytics client 112. Such operations include transmitting data to and receiving data from the experience analytics client 112. Data exchanges to and from the experience analytics server system 106 are invoked and controlled through functions available via user interfaces (UIs) of the experience analytics client 112.

The experience analytics server system 106 provides server-side functionality via the network 110 to a particular experience analytics client 112. While certain functions of the experience analytics system 100 are described herein as being performed by either an experience analytics client 112 or by the experience analytics server system 106, the location of certain functionality either within the experience analytics client 112 or the experience analytics server system 106 may be a design choice. For example, it may be technically preferable to initially deploy certain technology and functionality within the experience analytics server system 106 but to later migrate this technology and functionality to the experience analytics client 112 where a member client device 102 has sufficient processing capacity.

Turning now specifically to the experience analytics server system 106, an Application Program Interface (API) server 116 is coupled to, and provides a programmatic interface to, application servers 120. The application servers 120 are communicatively coupled to a database server 124, which facilitates access to a database 300 that stores data associated with experience analytics processed by the application servers 120. Similarly, a web server 118 is coupled to the application servers 120, and provides web-based interfaces to the application servers 120. To this end, the web server 118 processes incoming network requests over the Hypertext Transfer Protocol (HTTP) and several other related protocols.

The Application Program Interface (API) server 116 receives and transmits message data (e.g., commands and message payloads) between the member client device 102 and the application servers 120. Specifically, the Application Program Interface (API) server 116 provides a set of interfaces (e.g., routines and protocols) that can be called or queried by the experience analytics client 112 or the experience analytics script 114 in order to invoke functionality of the application servers 120. The Application Program Interface (API) server 116 exposes to the experience analytics client 112 various functions supported by the application servers 120, including generating information on errors, insights, merchandising information, adaptability information, images, graphs providing visualizations of experience analytics, session replay videos, zoning and overlays to be applied on the website, etc.

The application servers 120 host a number of server applications and subsystems, including for example an experience analytics server 122. The experience analytics server 122 implements a number of data processing technologies and functions, particularly related to the aggregation and other processing of data including the changes in the interface of the website being displayed on the customer client device 104, the elements on the website being displayed or visible on the interface of the customer client device 104, the text inputs by the user into the website, a movement of a mouse (or touchpad) cursor and mouse (or touchpad) clicks on the interface of the website, etc. received from multiple instances of the experience analytics script 114 on customer client devices 104. The experience analytics server 122 implements processing technologies and functions, related to generating user interfaces including information on errors, insights, merchandising information, adaptability information, images, graphs providing visualizations of experience analytics, session replay videos, zoning and overlays to be applied on the website, etc. Other processor and memory intensive processing of data may also be performed server-side by the experience analytics server 122, in view of the hardware requirements for such processing.

In one or more embodiments, the experience analytics server 122 is configured to execute instructions for streaming live sessions (e.g., live browsing sessions). As is relevant to the execution of instructions for streaming live sessions, live sessions are real-time or near-real-time representations of user journeys through a webpage or set of webpages, including the users' interactions therewith.

The experience analytics server 122 may be configured to activate a “live mode” or other, similar, program, routine, or the like, in response to the receipt, collection, or the like, of one or more “live mode” trigger commands, instructions, or the like, as may be sent by the experience analytics script 114, as described above. Such “live mode” routines may include, without limitation, increasing session event processing frequency, initiating one or more post-to-SLQ processes, such as may be applicable to the population of the short-latency queue (SLQ) 118 with live replay events and data, and the like.

The SLQ 126 may provide for collection, receipt, or the like, of session events, including session events in the order of collection or receipt. The SLQ 126 is a memory, storage, or other, like, component, configured to provide real-time or near-real-time storage of session events, such as clicks, scrolls, text entries, and the like, in the order in which such session events are generated during a user's session, as well as subsequent retrieval or transmission of such stored events, including in order, in real-time or near-real-time, as described hereinbelow. The SLQ 126 may be configured as a virtual component, as a physical component, or in a hybrid physical-virtual configuration.

In one or more embodiments, the database 300 is configured to archive data permanently or semi-permanently. The database 300 may be configured to store information received from one or more web third-party servers 108 (e.g., based on a request from the experience analytics server 122 to the third-party servers 108 for information, such as webpage content), customer client devices 104, and other, like, components, as well as to store data relevant to the operation of the experience analytics server 122 and any outputs therefrom. The database 300 may be a local system, a remote system, or a hybrid remote-local system. Further, the database 300 may be configured as a fully-physical system, including exclusively physical components, as a virtualized system, including virtualized components, or as a hybrid physical-virtual system. Examples of devices which may be configured as a database 300 in the experience analytics system 100 include, without limitation, local database hardware, cloud storage systems, remote storage servers, other, like, devices, and any combination thereof. Further, the database 300 may be directly connected to the experience analytics server 122, such as without an intermediate connection to the network 110, including via connections similar or identical to those described with respect to the network 110.

In one or more embodiments, the database 300 may be configured to store or otherwise archive data relating to one or more sessions, including, without limitation, user interactions, user sessions, other, like, data, and any combination thereof. Further, the database 300 may be configured to transfer, to and from the experience analytics server 122, data necessary for the execution of the methods described herein, and may store or otherwise archive experience analytics server 122 inputs, experience analytics server 122 outputs, or both.

As an example of a potential use-case involving the experience analytics system 100, as may be relevant to the descriptions provided herein, a user may attempt to access a website to purchase a product. The user may, through the customer client device 104, and a browser app included therein, generate a request to access the website. The request, when received by the third-party server 108, may configure the third-party server 108 to send a copy of webpage(s) of the website to the customer client device 104, including the experience analytics script 114. The database 300 may store a copy of the webpage(s) from the third-party servers 108 (e.g., based on a request from the experience analytics server 122 to the third-party servers 108). The experience analytics server 122 may provide such copy to the customer client device 104. During the course of the customer client's session, the experience analytics script 114 may collect session data and transmit such data to the experience analytics server 122 for storage in the database 300.

In addition, where the user at the customer client device 104 encounters an issue (e.g., an error such a defective checkout button, user confusion, and/or another type of issue), the user may engage a live help support feature (e.g., implemented by the experience analytics server 122), for example, by selecting a chat button. In this regard, the help support feature includes a chat component, which allows a support agent at the member client device 102 to chat with the user at the customer client device 104. Moreover, the help support feature allows the user to connect with the help agent, causing the experience analytics script 114 to employ a script interface (e.g., a Javascript API) to make data available for the member client device 102 (e.g., such that when the live session link/button is pressed, this data is visible to the agent), and to send a live mode trigger to the experience analytics server system 106. Following receipt of the live mode trigger by the experience analytics server system 106, the user's session data may be pushed to the SLQ 126 of the experience analytics server 122, in real-time or near-real-time. The experience analytics server 122 sends the live session link to the member client device 102, where the live session link is selectable by the help agent.

Following a help agent's activation of the live session link, the experience analytics server 122 may be configured to provide live session replay to the member client device 102. For example, the experience analytics server 122 generates a combined SLQ 126 and database 300 data feed, and provides the combined data feed to the help agent at the member client device 102, in real-time or near-real-time, permitting the help agent to view the user's live session, and provide suggestions regarding how the user can better engage with the website. The merging allows the help agent to seek back (e.g., rewind) to view what happened, even before the website visitor at the customer client device 104 pressed the chat button.

### System Architecture

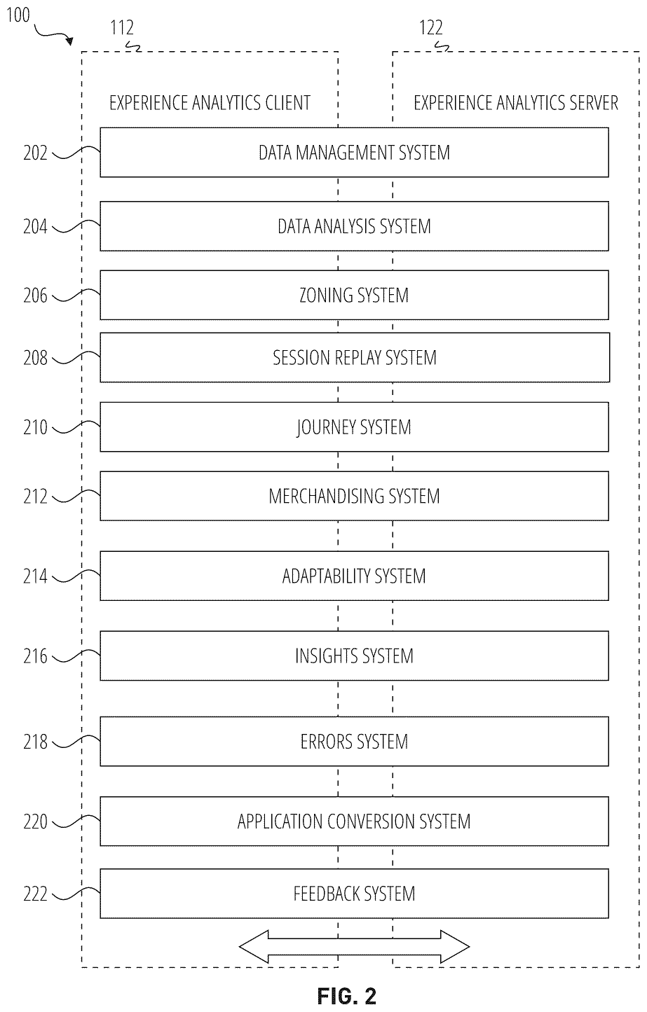

FIG. 2 is a block diagram illustrating further details regarding the experience analytics system 100 according to some examples. Specifically, the experience analytics system 100 is shown to comprise the experience analytics client 112 and the experience analytics server 122. The experience analytics system 100 embodies a number of subsystems, which are supported on the client-side by the experience analytics client 112 and on the server-side by the experience analytics server 122. These subsystems include, for example, a data management system 202, a data analysis system 204, a zoning system 206, a session replay system 208, a journey system 210, a merchandising system 212, an adaptability system 214, an insights system 216, an errors system 218, and an application conversion system 220.

The data management system 202 is responsible for receiving functions or data from the processors 1404, the experience analytics script 114 executed by each of the customer client devices 104, and the third-party servers 108. The data management system 202 is also responsible for exporting data to the processors 1404 or the third-party servers 108 or between the systems in the experience analytics system 100. The data management system 202 is also configured to manage the third-party integration of the functionalities of experience analytics system 100.

The data analysis system 204 is responsible for analyzing the data received by the data management system 202, generating data tags, performing data science and data engineering processes on the data.

The zoning system 206 is responsible for generating a zoning interface to be displayed by the processors 1404 via the experience analytics client 112. The zoning interface provides a visualization of how the users via the customer client devices 104 interact with each element on the client's website. The zoning interface can also provide an aggregated view of in-page behaviors by the users via the customer client device 104 (e.g., clicks, scrolls, navigation). The zoning interface can also provide a side-by-side view of different versions of the client's website for the client's analysis. For example, the zoning system 206 can identify the zones in a client's website that are associated with a particular element in displayed on the website (e.g., an icon, a text link, etc.). Each zone can be a portion of the website being displayed. The zoning interface can include a view of the client's website. The zoning system 206 can generate an overlay including data pertaining to each of the zones to be overlaid on the view of the client's website. The data in the overlay can include, for example, the number of views or clicks associated with each zone of the client's website within a period of time, which can be established by the user of the processors 1404. In one example, the data can be generated using information from the data analysis system 204.

The session replay system 208 is responsible for generating the session replay interface to be displayed by the processors 1404 via the experience analytics client 112. The session replay interface includes a session replay that is a video reconstructing an individual user's session (e.g., visitor session) on the client's website. The user's session starts when the user arrives into the client's website and ends upon the user's exit from the client's website. A user's session when visiting the client's website on a customer client device 104 can be reconstructed from the data received from the user's experience analytics script 114 on customer client devices 104. The session replay interface can also include the session replays of a number of different visitor sessions to the client's website within a period of time (e.g., a week, a month, a quarter, etc.). The session replay interface allows the client via the processors 1404 to select and view each of the session replays. In one example, the session replay interface can also include an identification of events (e.g., failed conversions, angry customers, errors in the website, recommendations or insights) that are displayed and allow the user to navigate to the part in the session replay corresponding to the events such that the client can view and analyze the event.

The journey system 210 is responsible for generating the journey interface to be displayed by the processors 1404 via the experience analytics client 112. The journey interface includes a visualization of how the visitors progress through the client's website, page-by-page, from entry onto the website to the exit (e.g., in a session). The journey interface can include a visualization that provides a customer journey mapping (e.g., sunburst visualization). This visualization aggregates the data from all of the visitors (e.g., users on different customer client devices 104) to the website, and illustrates the visited pages and in order in which the pages were visited. The client viewing the journey interface on the processors 1404 can identify anomalies such as looping behaviors and unexpected drop-offs. The client viewing the journey interface can also assess the reverse journeys (e.g., pages visitors viewed before arriving at a particular page). The journey interface also allows the client to select a specific segment of the visitors to be displayed in the visualization of the customer journey.

The merchandising system 212 is responsible for generating the merchandising interface to be displayed by the processors 1404 via the experience analytics client 112. The merchandising interface includes merchandising analysis that provides the client with analytics on: the merchandise to be promoted on the website, optimization of sales performance, the items in the client's product catalog on a granular level, competitor pricing, etc. The merchandising interface can, for example, comprise graphical data visualization pertaining to product opportunities, category, brand performance, etc. For instance, the merchandising interface can include the analytics on conversions (e.g., sales, revenue) associated with a placement or zone in the client website.

The adaptability system 214 is responsible for creating accessible digital experiences for the client's website to be displayed by the customer client devices 104 for users that would benefit from an accessibility-enhanced version of the client's website. For instance, the adaptability system 214 can improve the digital experience for users with disabilities, such as visual impairments, cognitive disorders, dyslexia, and age-related needs. The adaptability system 214 can, with proper user permissions, analyze the data from the experience analytics script 114 to determine whether an accessibility-enhanced version of the client's website is needed, and can generate the accessibility-enhanced version of the client's website to be displayed by the customer client device 104.

The insights system 216 is responsible for analyzing the data from the data management system 202 and the data analysis system 204 surface insights that include opportunities as well as issues that are related to the client's website. The insights can also include alerts that notify the client of deviations from a client's normal business metrics. The insights can be displayed by the processors 1404 via the experience analytics client 112 on a dashboard of a user interface, as a pop-up element, as a separate panel, etc. In this example, the insights system 216 is responsible for generating an insights interface to be displayed by the processors 1404 via the experience analytics client 112. In another example, the insights can be incorporated in another interface such as the zoning interface, the session replay, the journey interface, or the merchandising interface to be displayed by the processors 1404.

The errors system 218 is responsible for analyzing the data from the data management system 202 and the data analysis system 204 to identify errors that are affecting the visitors to the client's website and the impact of the errors on the client's business (e.g., revenue loss). The errors can include the location within the user journey in the website and the page that adversely affects (e.g., causes frustration for) the users (e.g., users on customer client devices 104 visiting the client's website). The errors can also include causes of looping behaviors by the users, in-page issues such as unresponsive calls to action and slow loading pages, etc. The errors can be displayed by the processors 1404 via the experience analytics client 112 on a dashboard of a user interface, as a pop-up element, as a separate panel, etc. In this example, the errors system 218 is responsible for generating an errors interface to be displayed by the processors 1404 via the experience analytics client 112. In another example, the insights can be incorporated in another interface such as the zoning interface, the session replay, the journey interface, or the merchandising interface to be displayed by the processors 1404.

The application conversion system 220 is responsible for the conversion of the functionalities of the experience analytics server 122 as provided to a client's website to a client's native mobile applications. For instance, the application conversion system 220 generates the mobile application version of the zoning interface, the session replay, the journey interface, the merchandising interface, the insights interface, and the errors interface to be displayed by the processors 1404 via the experience analytics client 112. The application conversion system 220 generates an accessibility-enhanced version of the client's mobile application to be displayed by the customer client devices 104. the feedback data received from the client devices. As the visitor progresses through a client's website on the client device, a feedback webpage of the website, a pop-up window or tab, or an overlay can be displayed to receive the visitor's feedback. For instance, a feedback form can be displayed in a pop-up window or tab of the website, an overlay of the website, one of the plurality of webpages of the website, etc. The visitor can provide feedback on, for example, the functionality of the website, aesthetics of the website, on the goods and services associated with the website, etc. The feedback data can include a text input that is included into a feedback form on the website. The feedback data can also include a survey response, a rating that includes an image, an emoticon, or an icon, a screenshot of one of the plurality of webpages, etc. The feedback system 222 is also responsible for generating feedback interfaces to be displayed by the member client device 102 via the experience analytics client 112.

The feedback system 222 is responsible for receiving and analyzing data from the data management system 202 that includes the feedback data received from the client devices. As the visitor progresses through a client's website on the client device, a feedback webpage of the website, a pop-up window or tab, or an overlay can be displayed to receive the visitor's feedback. For instance, a feedback form can be displayed in a pop-up window or tab of the website, an overlay of the website, one of the plurality of webpages of the website, etc. The visitor can provide feedback on, for example, the functionality of the website, aesthetics of the website, on the goods and services associated with the website, etc. The feedback data can include a text input that is included into a feedback form on the website. The feedback data can also include a survey response, a rating that includes an image, an emoticon, or an icon, a screenshot of one of the plurality of webpages, etc. The feedback system 222 is also responsible for generating feedback interfaces to be displayed by the member client device 102 via the experience analytics client 112. Feedback interface can include the feedback list user interface, the feedback entry detail user interface, and playback user interface.

### Data Architecture

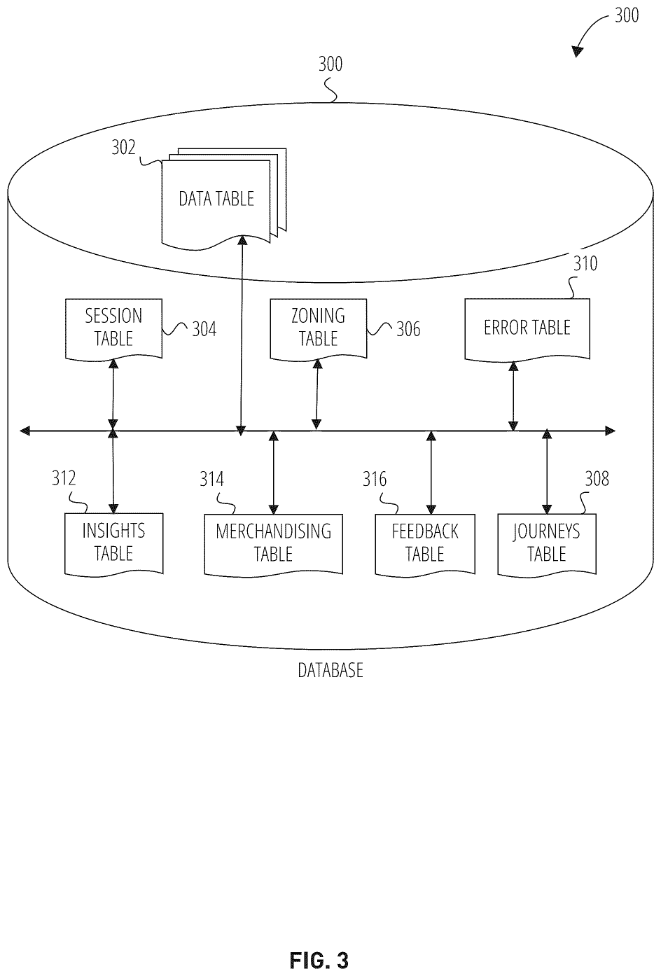

FIG. 3 is a schematic diagram illustrating database 300, which may be stored in the database 300 of the experience analytics server 122, according to certain examples. While the content of the database 300 is shown to comprise a number of tables, it will be appreciated that the data could be stored in other types of data structures (e.g., as an object-oriented database).

The database 300 includes a data table 302, a session table 304, a zoning table 306, an error table 310, an insights table 312, a merchandising table 314, and a journeys table 308.

The data table 302 stores data regarding the websites and native applications associated with the clients of the experience analytics system 100. The data table 302 can store information on the contents of the website or the native application, the changes in the interface of the website being displayed on the customer client device 104, the elements on the website being displayed or visible on the interface of the customer client device 104, the text inputs by the user into the website, a movement of a mouse (or touchpad or touch screen) cursor and mouse (or touchpad or touch screen) clicks on the interface of the website, etc. The data table 302 can also store data tags and results of data science and data engineering processes on the data. The data table 302 can also store information such as the font, the images, the videos, the native scripts in the website or applications, etc.

The session table 304 stores session replays for each of the client's websites and native applications. Session replays may include session events associated with browsing sessions. In one or more embodiments, session events correspond to user interactions with one or more elements, sections, zones (e.g., stored in association with the zoning table 306 discussed below), or the like, of a webpage. Examples of session events include, but are not limited to, user input of entering text in a text box, clicking a button with a mouse, tapping a button with a touchscreen, navigating to a webpage, navigating away from a webpage, scrolling up or down on the webpage, hovering over a webpage element, and the like, as well as any combination thereof. Session replay and recording may be executed by generating one or more logs, lists, and the like, of such events (e.g., as detected by an experience analytics script 114) included in a webpage accessed by a user of the customer client device 104. Such logs, lists, and the like may be stored in the session table 304, and may include one or more event descriptors including the event type, the event target, such as a specific button or text box, the event time, and the like, as well as combinations thereof.

The zoning table 306 stores data related to the zoning for each of the client's websites and native applications including the zones to be created and the zoning overlay associated with the websites and native applications. The journeys table 308 stores data related to the journey of each visitor to the client's website or through the native application. The error table 310 stores data related to the errors generated by the errors system 218 and the insights table 312 stores data related to the insights generated by the insights table 312.

The merchandising table 314 stores data associated with the merchandising system 212. For example, the data in the merchandising table 314 can include the product catalog for each of the clients, information on the competitors of each of the clients, the data associated with the products on the websites and applications, the analytics on the product opportunities and the performance of the products based on the zones in the website or application, etc.

The feedback table 316 stores data associated with the feedback system 222. For example, the data in the feedback table 316 can include the feedback data received from each of the customer client devices 104 and stored in association with the customer client device 104 and the website associated with the customer client device 104. The feedback data can include, for example, the text input that provides the visitor's (or customer's) feedback on the website, survey response, rating that includes an image, an emoticon, or an icon, a screenshot of one of the plurality of webpages, etc.

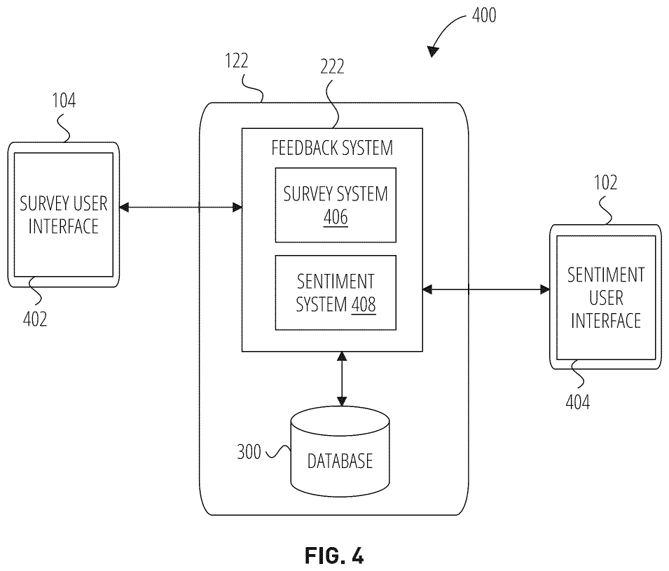

FIG. 4 illustrates an architecture 400 for performing sentiment analysis for survey responses, in accordance with some examples. For explanatory purposes, the architecture 400 is primarily described herein with reference to the member client device 102, the customer client device 104 and the experience analytics server 122 of FIG. 1. However, the architecture 400 may correspond to one or more other components and/or other suitable devices.

As noted above with respect to FIG. 2, the experience analytics server 122 includes a feedback system 222, which is configured to receive and analyze feedback received from the customer client devices 104. As the user (e.g., customer) progresses through a website on the customer client device 104, the survey system 406 is configured to provide one or more survey user interfaces 402 for responding to the website. For example, the survey user interface 402 may correspond to one or more of a feedback form for the website, a pop-up window or tab, or an overlay can be displayed to receive the user's feedback (e.g., responses to surveys). The user of the customer client device 104 provides webpage/website feedback for example, on the functionality of a webpage (e.g., or entire website), aesthetics of the webpage/website, the goods and services associated with the website, and the like, via the survey user interface 402.

In example embodiments, the survey responses (e.g., feedback data) provided by the user corresponds to text input that is included into a feedback form on the website. The survey responses (e.g., feedback data) can include individual responses (e.g., text-based responses) to survey questions, a rating that includes an image, an emoticon, or an icon, a screenshot of one of the plurality of webpages, etc. The survey system 406 is configured to store the feedback data/survey responses within the feedback table 316 of the database 300. For example, the survey system 406 stores the question-response pair for each question of a given survey within the feedback table 316 of the database 300.

Moreover, the feedback system 222 is configured to access the question-response pairs stored within the feedback table 316, in order to generate sentiment/feedback metrics within a sentiment user interface 404, for display on the member client device 102. For example, the sentiment user interface 404 includes user-selectable elements for a user (e.g., a client member) to view sentiment results and/or metrics based on the stored question-response pairs for survey(s). In response to user selection to view the metrics, the sentiment system 408 performs sentiment analysis based on the question-response pairs, and displays corresponding sentiment results/metrics within the sentiment user interface 404.

In example embodiments, for a given survey response, the sentiment system 408 is configured to interpret a respective sentiment of positive, negative or neutral for that survey response. In doing so, the sentiment system 408 is configured to generate a prompt (e.g., an Open AI prompt such as a ChatGPT prompt) requesting the sentiment classification (e.g., of positive, negative or neutral) for the respective question and response pair. The sentiment system 408 provides the prompt to a large language model through an API (e.g., Open AI-based chat completions API). The sentiment system 408 receives, from the large language model, the sentiment classification of each of the respective question-response pairs.

While the example of FIG. 4 describes the use of an API such as OpenAI's chat completions, the experience analytics server 122 is not limited to such, and can instead implement or otherwise access other large language models (e.g., corresponding to one or more neural networks) capable of determining sentiment from text-based question-response pairs. For example, the experience analytics server 122 implements or otherwise accesses a combination of neural network models (e.g., generative artificial intelligence models) in order to determine sentiment classifications (e.g., sentiment tags). The combination of neural network models may include one or more large language models, and corresponds to transformer-based models which are fine-tuned on survey response data to understand the language and terminology in surveys. For example, the combination of neural network models includes one or more generative pre-trained transformers (e.g., OpenAI) in combination with additional models pre-trained on survey response data for extracting rules from surveys.

In example aspects, the sentiment system 408 is configured to provide prompts to the large language model in a batched manner, for improved efficiency and cost with respect to computational resources. For example, the sentiment system 408 is configured to access survey data (e.g., question-response pairs) based on past surveys, current surveys (e.g., provided and saved in real-time or near real-time), or a combination of past surveys and current surveys. The sentiment system 408 is configured to batch question-response pairs as single prompts, to reduce computational resources and/or cost and improve efficiency with respect to interfacing with the large language model.

While the example of FIG. 4 is depicted as a single customer client device 104, it is possible that the experience analytics server 122 provides for aggregating survey responses from multiple customer client devices 104. The aggregated data is stored in the database 300, and is usable by the feedback system 222 to present the sentiment user interface 404 with respect to the member client device 102.

By virtue of performing sentiment analysis in this manner, the sentiment system 408 provides for facilitated user engagement with respect to reviewing user satisfaction. For example, the sentiment system 408 reduces manual aspects (e.g., user input for creating a report/metrics of user satisfaction) associated with conventional techniques for sentiment analysis. In addition, the sentiment system 408 facilitates the user's ability to quickly understand the sentiment (e.g., via positive, negative and neutral tags) associated with surveys. Thus, the sentiment system 408 facilitates sentiment analysis, thereby saving time for end users, and reducing computational resources/processing power.

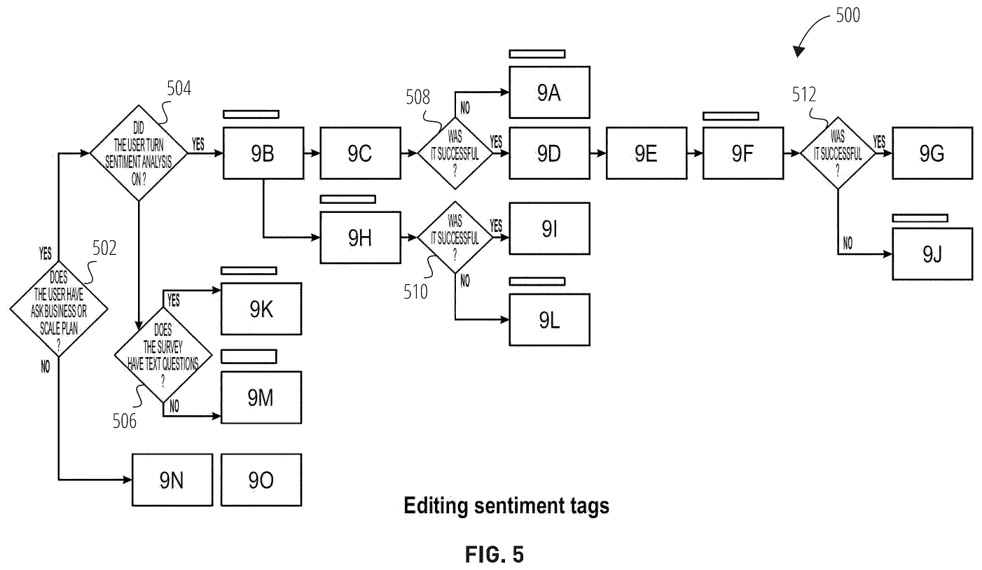

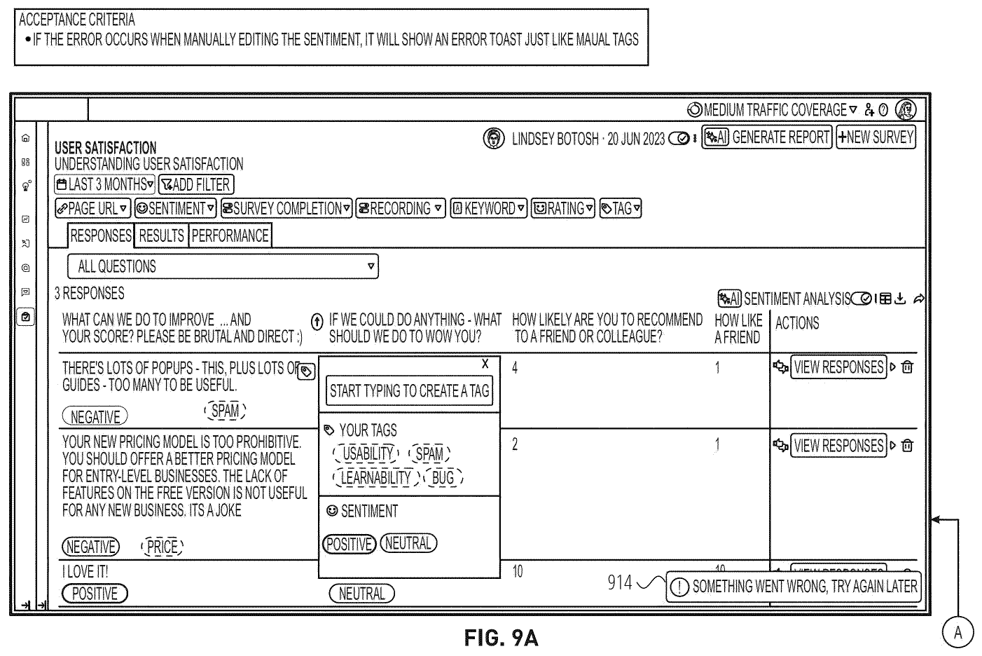

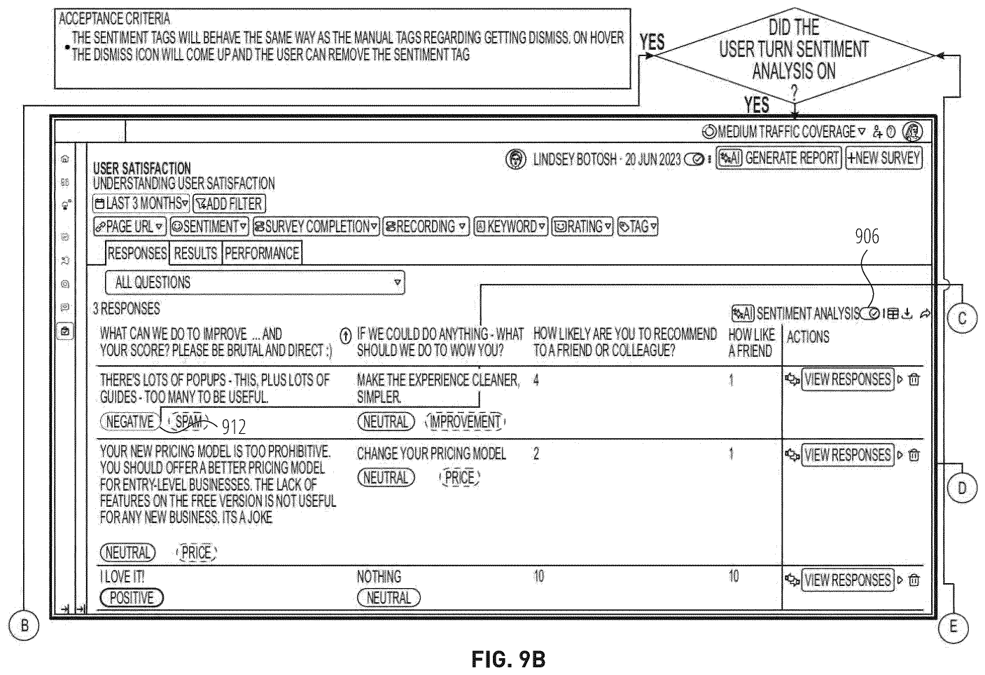

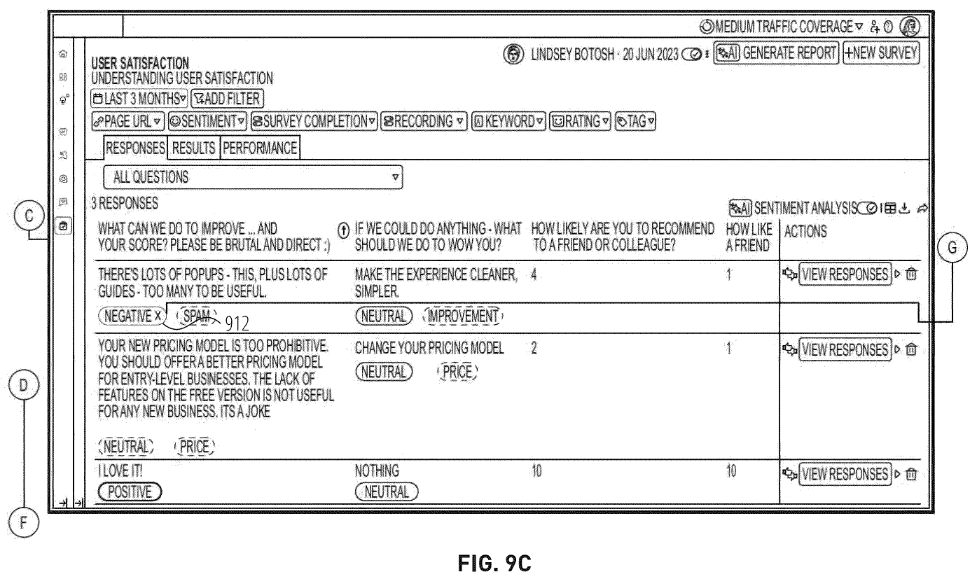

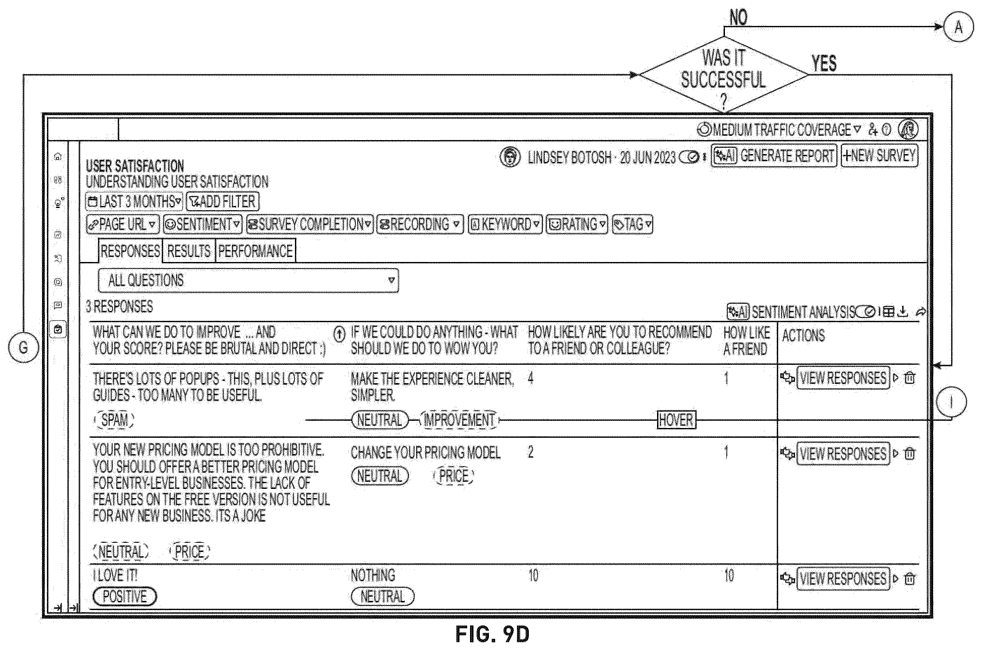

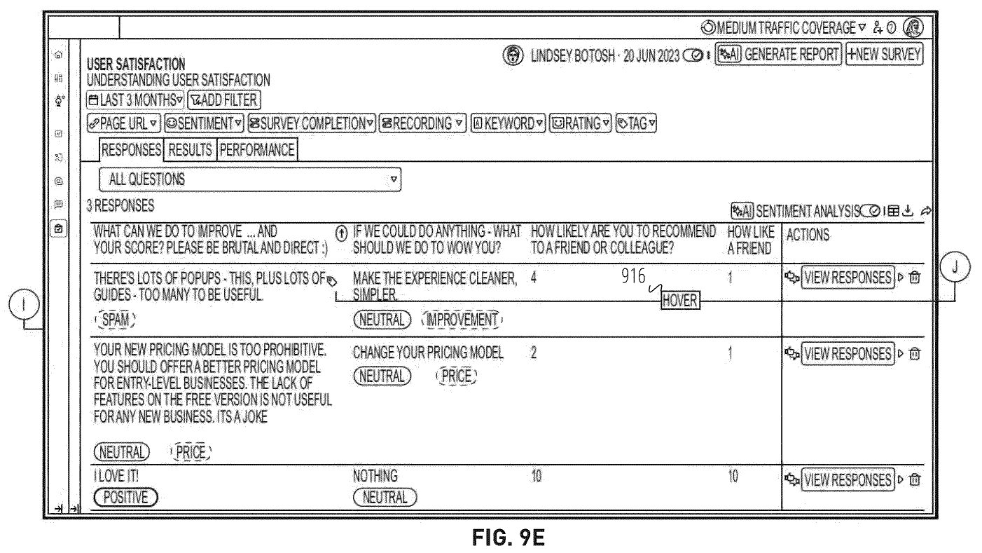

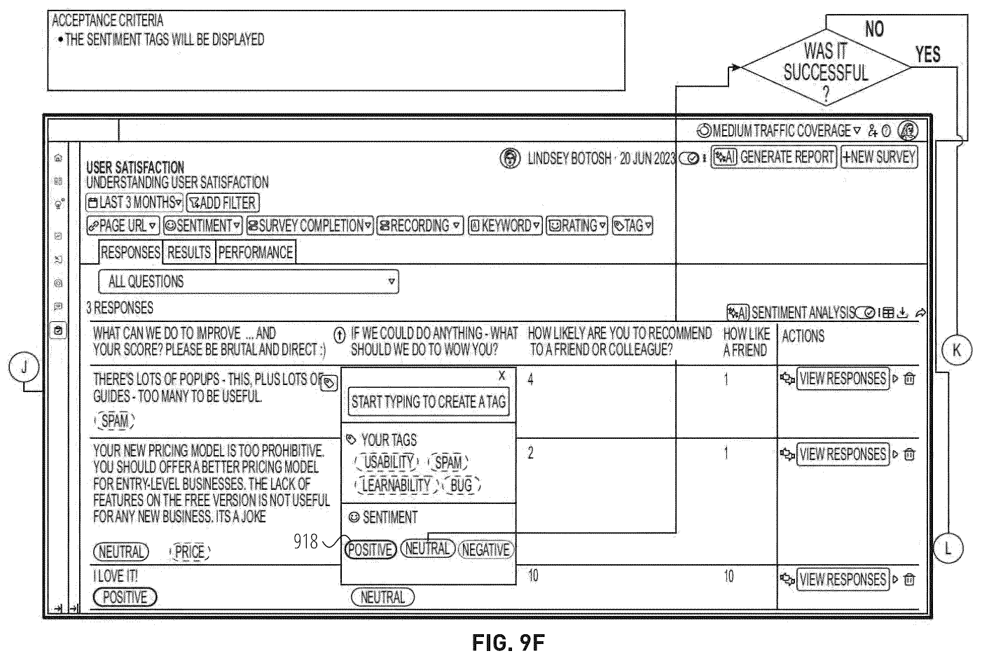

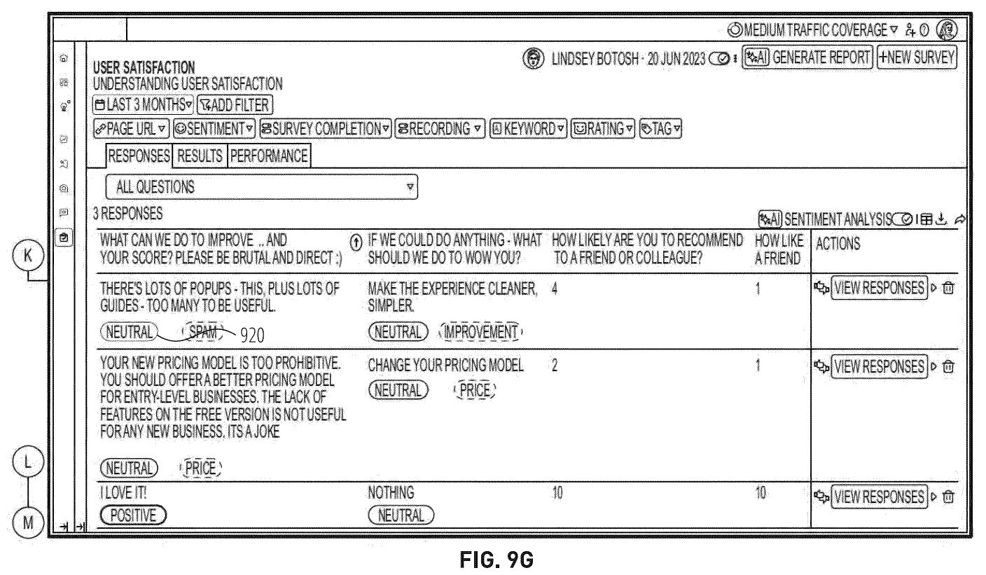

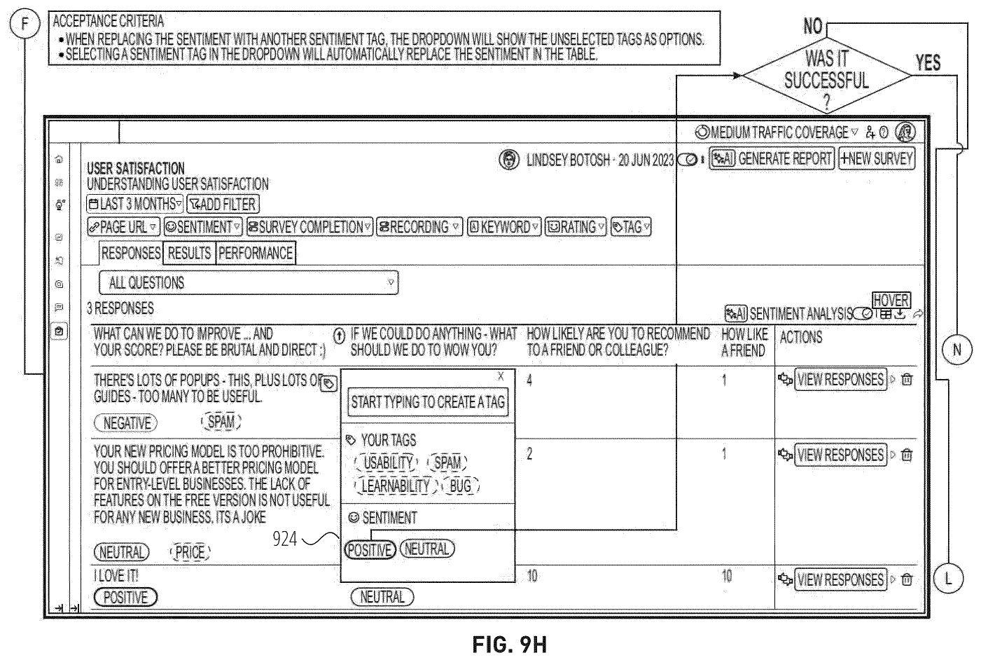

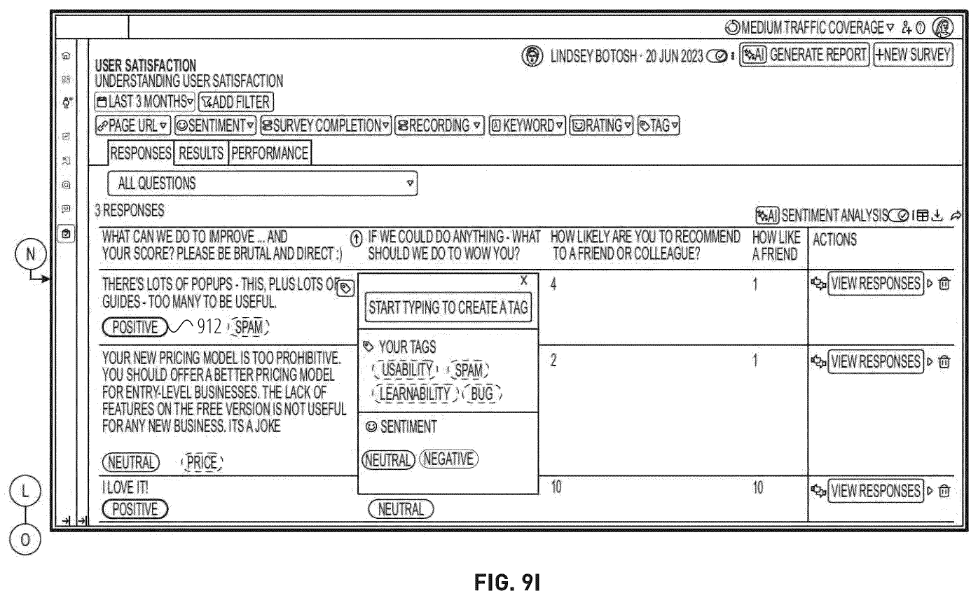

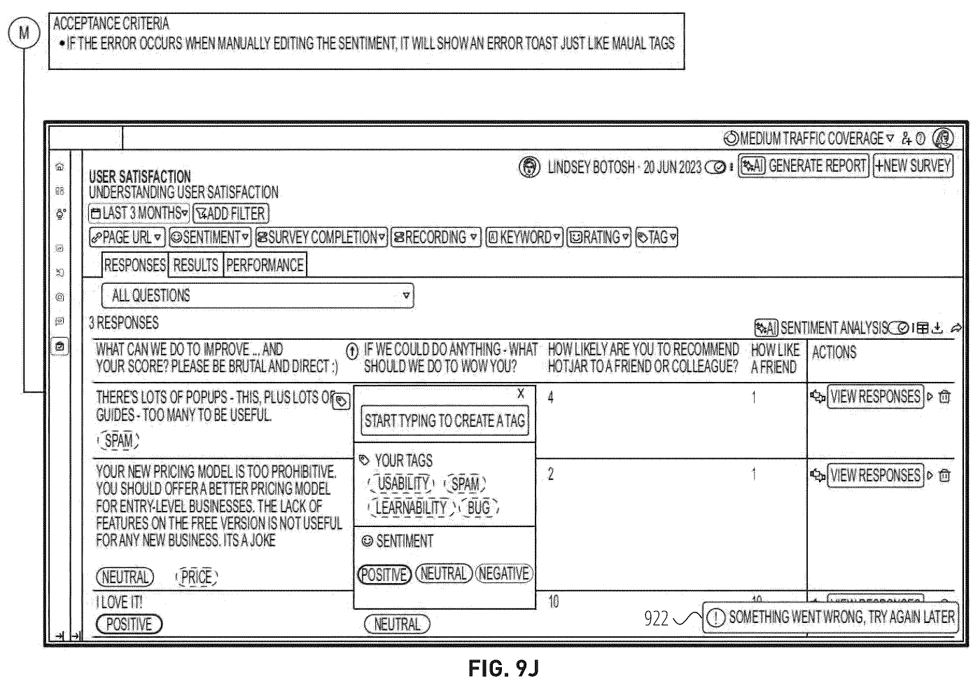

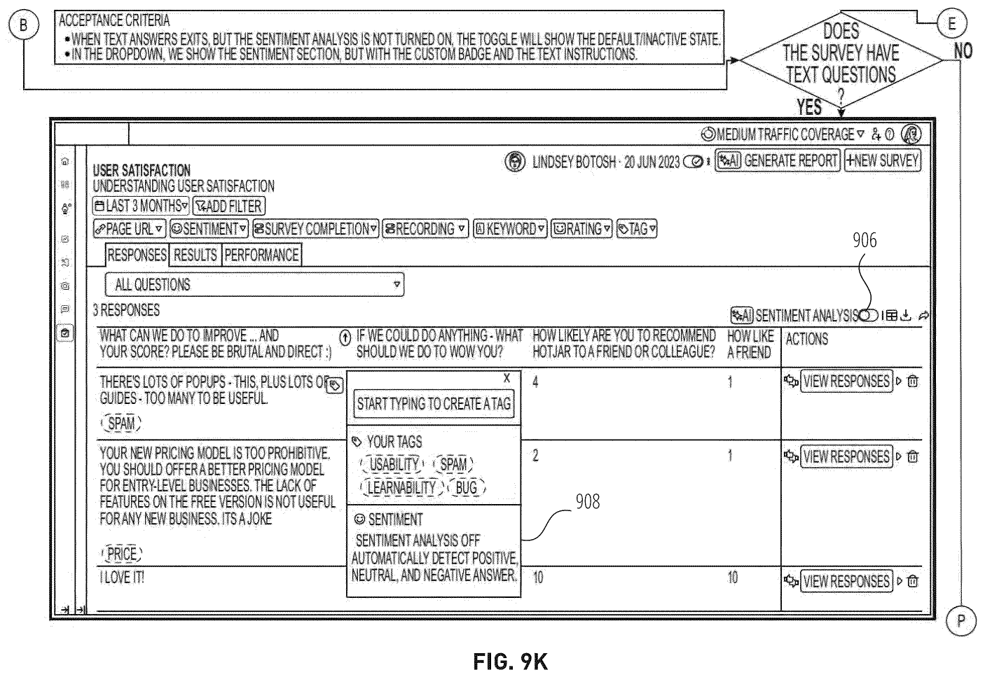

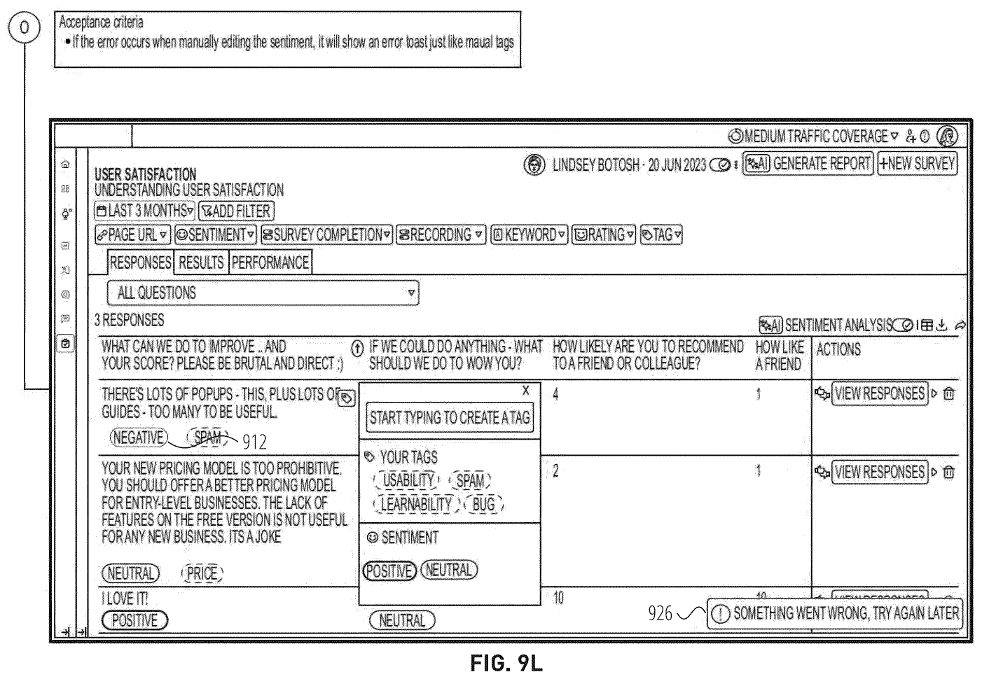

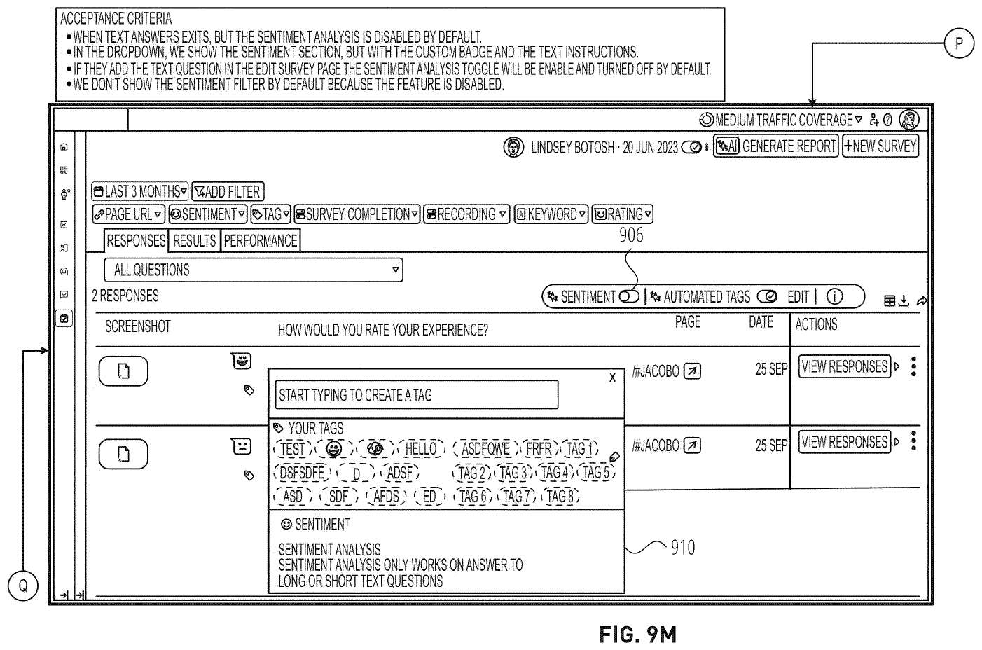

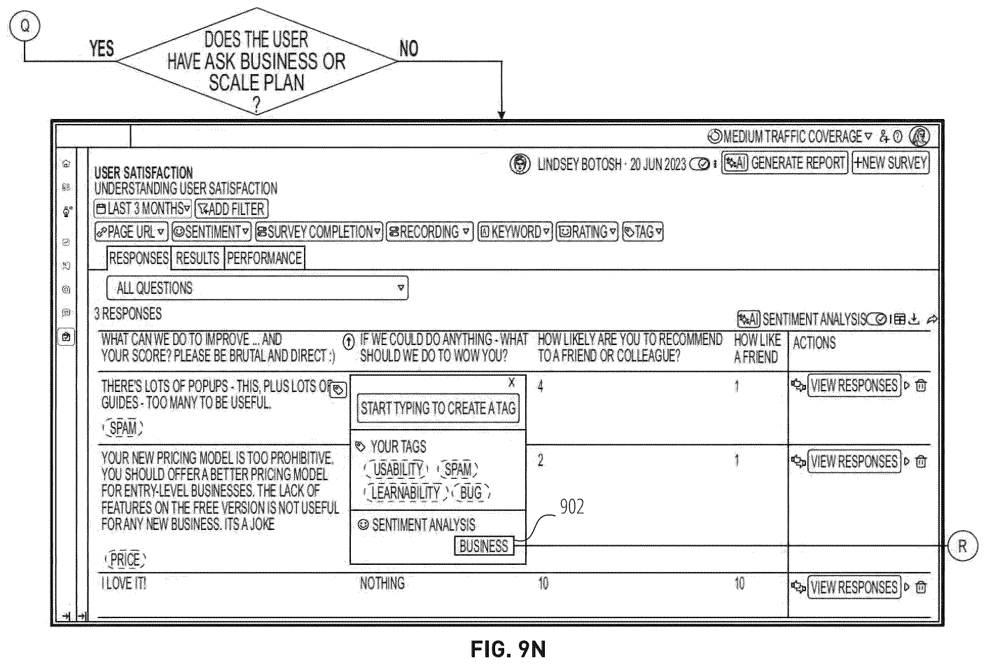

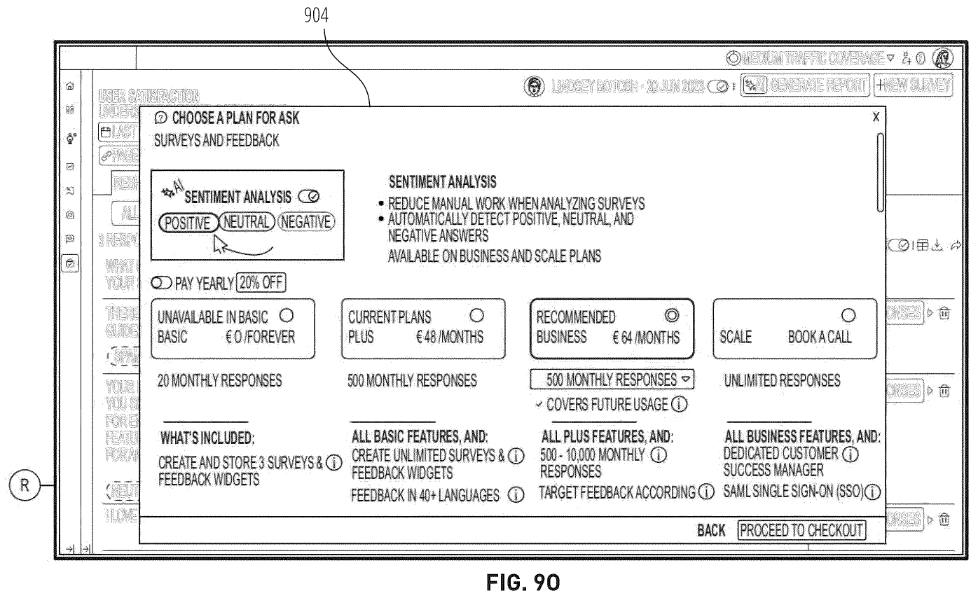

FIG. 5 illustrates a user interface flow 500 for editing sentiment tags with respect to performing sentiment analysis for survey responses, in accordance with some examples. In the example of FIG. 5, the user interface flow 500 includes decision blocks 502-512. In addition, the user interface flow 500 depicts blocks 9A-9O, which respectively correspond with the user interfaces of FIGS. 9A-9O. For explanatory purposes, the user interface flow 500 is primarily described herein with reference to the member client device 102, the customer client device 104 and the experience analytics server 122 of FIG. 1. However, one or more blocks (or operations) of the user interface flow 500 may be performed by one or more other components, and/or by other suitable devices. Further for explanatory purposes, the blocks (or operations) of the user interface flow 500 are described herein as occurring in serial, or linearly. However, multiple blocks (or operations) of the user interface flow 500 may occur in parallel or concurrently. In addition, the blocks (or operations) of the user interface flow 500 need not be performed in the order shown and/or one or more blocks (or operations) of the user interface flow 500 need not be performed and/or can be replaced by other operations. The user interface flow 500 may be terminated when its operations are completed. In addition, the user interface flow 500 may correspond to a method, a procedure, an algorithm, etc.

As noted above, the sentiment system 408 is configured to determine sentiment tags (e.g., classifications of positive, negative and neutral sentiment) based on question-response pairs stored in the database 300. The sentiment system 408 is further configured to store corresponding sentiment tags in association with each respective question-response pair within the feedback table 316 of the database 300. In response to user input selecting to view sentiment results/metrics (e.g., via the sentiment user interface 404), the sentiment system 408 provides for displaying the sentiment results/metrics (e.g., within the sentiment user interface 404).

At decision block 502, the sentiment system 408 determines whether a user at the member client device 102 has an ask business or scale plan (e.g., whether the user has subscribed/enrolled to the sentiment analysis feature offered by the experience analytics system 100). If the user does not have an ask business or scale plan, the sentiment system 408 proceeds with presenting the user interfaces of FIGS. 9N and 9O. As discussed further below, FIGS. 9N and 9O prompt the user to subscribe or otherwise enroll to a business or scale plan for sentiment analysis.

If the user does have an ask business or scale plan, the sentiment system 408 proceeds to decision block 504. At decision block 504, the sentiment system 408 determines if the user turned sentiment analysis on. If the user did not turn sentiment analysis on, the sentiment system 408 proceeds to decision block 506. At decision block 506, the sentiment system 408 determines whether the survey has text questions. If the survey does have text questions, the sentiment system 408 presents the user interface of FIG. 9K. As discussed further below, FIG. 9K indicates that sentiment analysis is disabled but available. If the survey does not have text questions per decision block 506, the sentiment system 408 presents the user interface of FIG. 9M. As discussed further below, FIG. 9M indicates that sentiment analysis is disabled and available but available for surveys with text-based questions.

If the user turned on sentiment analysis per decision block 504, the sentiment system 408 presents the user interface of FIG. 9B, and subsequently FIG. 9C or FIG. 9H, which are discussed further below. As discussed further below, FIGS. 9B, 9C and 9H relate to a user editing the sentiment classification (e.g., positive, negative, neutral) for a particular question and response pair.

After presenting the user interface of FIG. 9C, at decision block 508, the sentiment system 408 determines if user editing of a sentiment classification from FIG. 9C was successful. If it was not successful, the sentiment system 408 presents the user interface of FIG. 9A. As discussed further below, FIG. 9A indicates that an error occurred with respect to editing the sentiment classification. If the editing was successful per decision block 508, the sentiment system 408 presents the user interfaces of FIGS. 9D, 9E and 9F. As discussed further below, FIGS. 9D, 9E and 9F displays sentiment tags for editing the sentiment classification.

After presenting the user interface of FIG. 9F, the sentiment system 408 proceeds to decision block 512. At decision block 512, sentiment system 408 determines if user editing of the sentiment classification from FIG. 9F was successful. If it was successful, the sentiment system 408 presents the user interface FIG. 9G. As discussed further below, FIG. 9G displays the sentiment as updated by the user. If the editing was unsuccessful per decision block 512, the sentiment system 408 presents the user interface of FIG. 9J. As discussed further below, FIG. 9J indicates that an error occurred with respect to editing the sentiment classification.

After presenting the user interface of FIG. 9H, at decision block 510, the sentiment system 408 determines if user editing of a sentiment classification from FIG. 9H was successful. If it was not successful, the sentiment system 408 presents the user interface of FIG. 9L. As discussed further below, FIG. 9L indicates that an error occurred with respect to editing the sentiment classification. If the editing was successful per decision block 510, the sentiment system 408 presents the user interface of FIG. 9I. As discussed further below, FIG. 9I displays the sentiment as updated by the user.

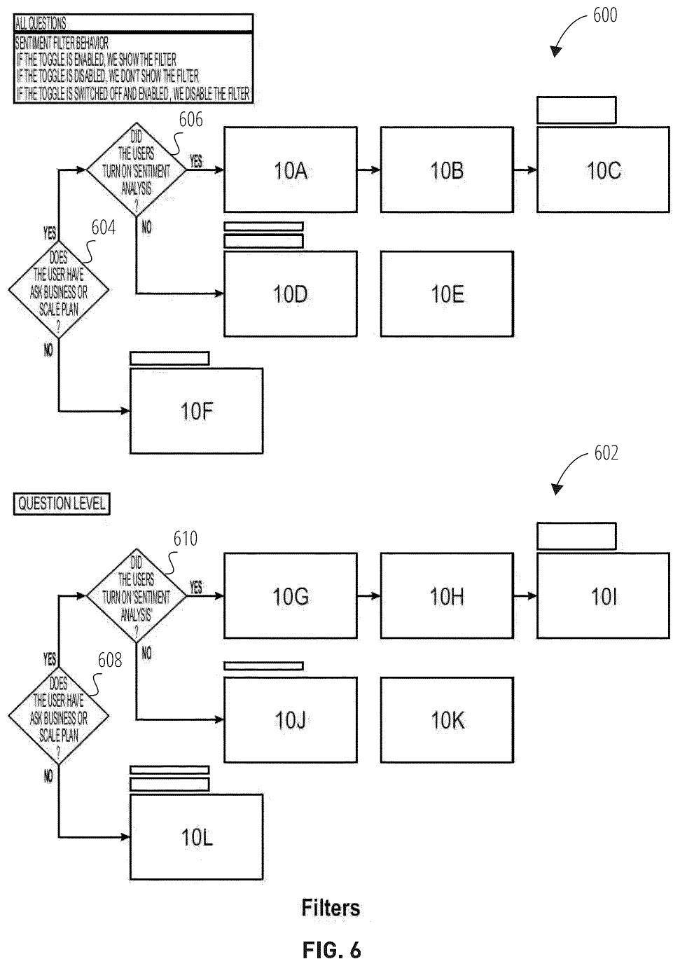

FIG. 6 illustrates a user interface flows 600 and 602 for applying filters with respect to performing sentiment analysis for survey responses, in accordance with some examples. As noted above, the sentiment system 408 is configured with user interface elements that allow a user at the member client device 102 (e.g., via the sentiment user interface 404) to apply filters with respect to sentiments (e.g., positive, negative, neutral).

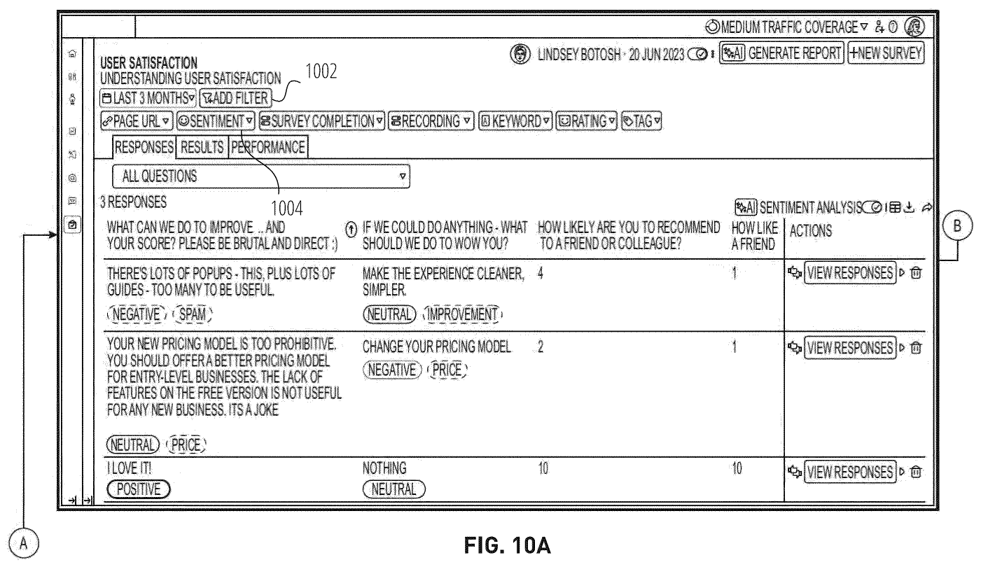

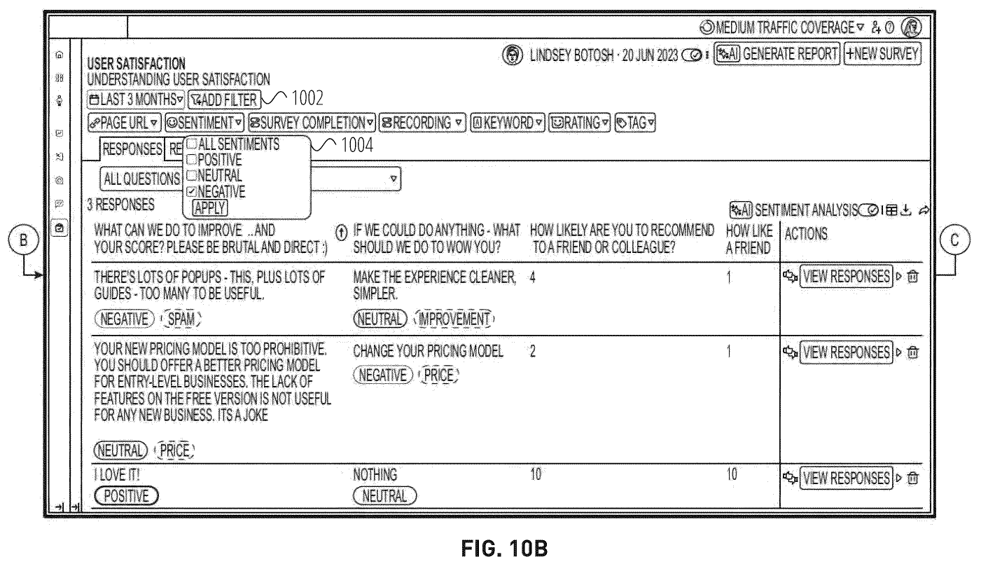

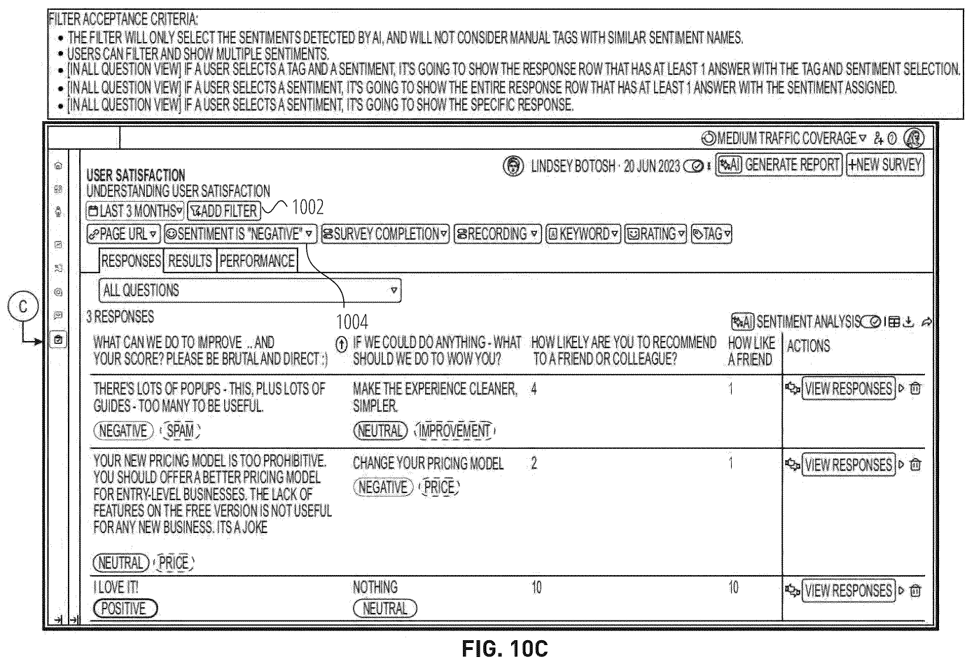

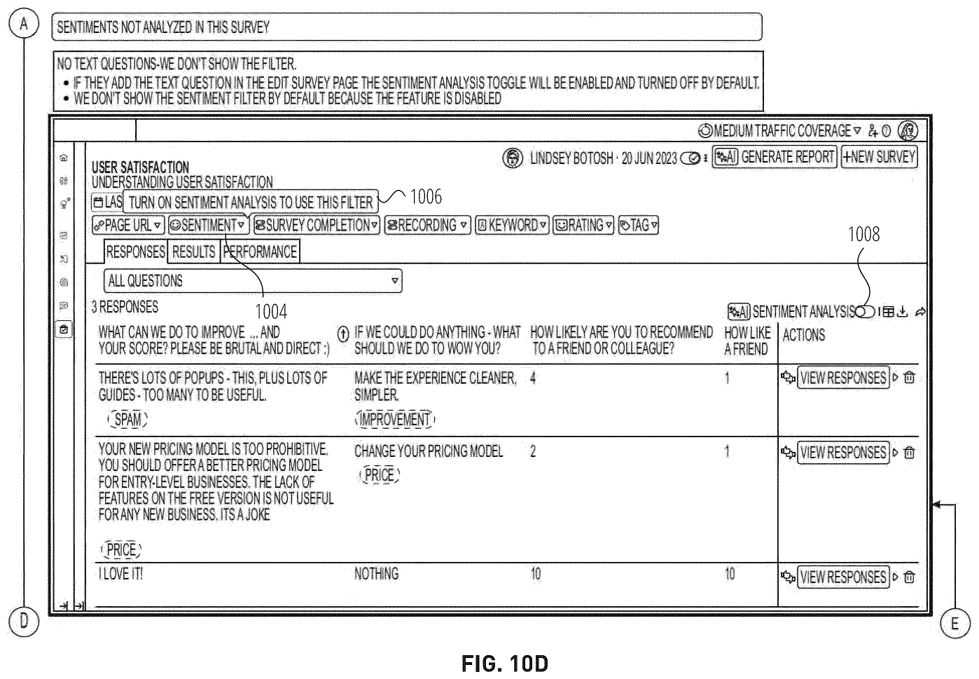

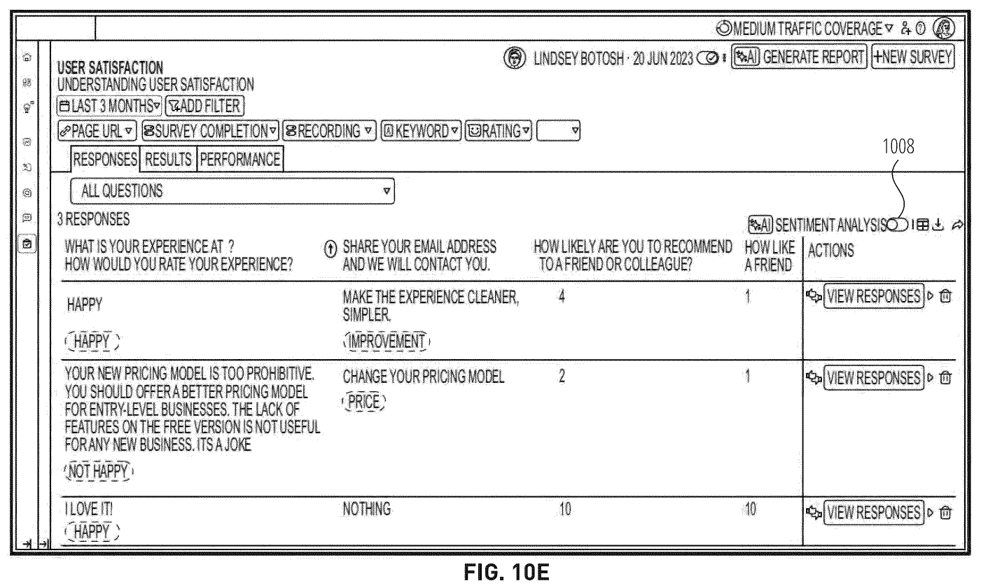

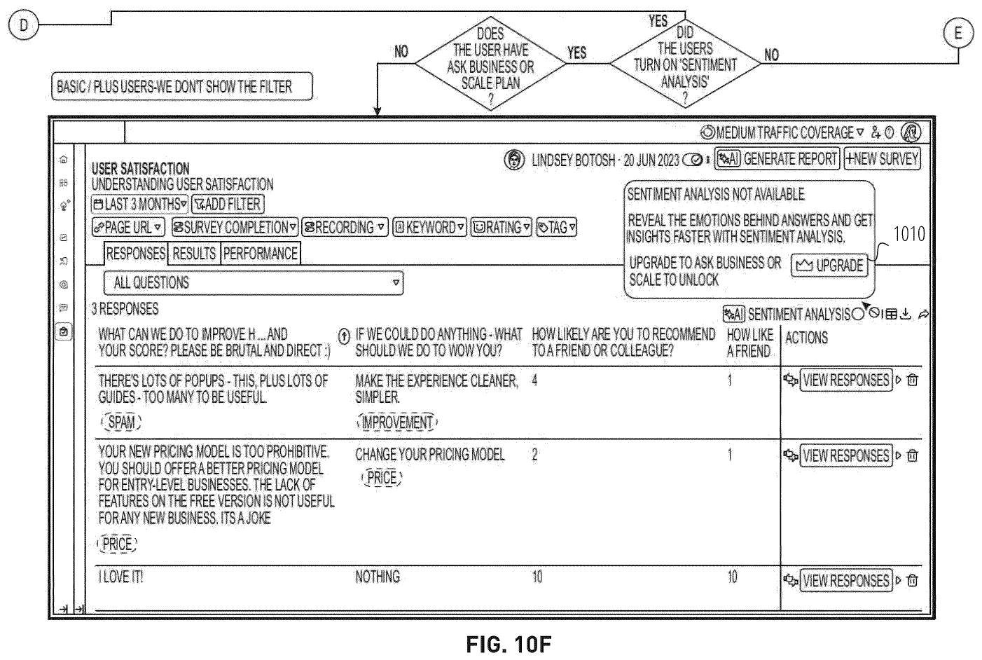

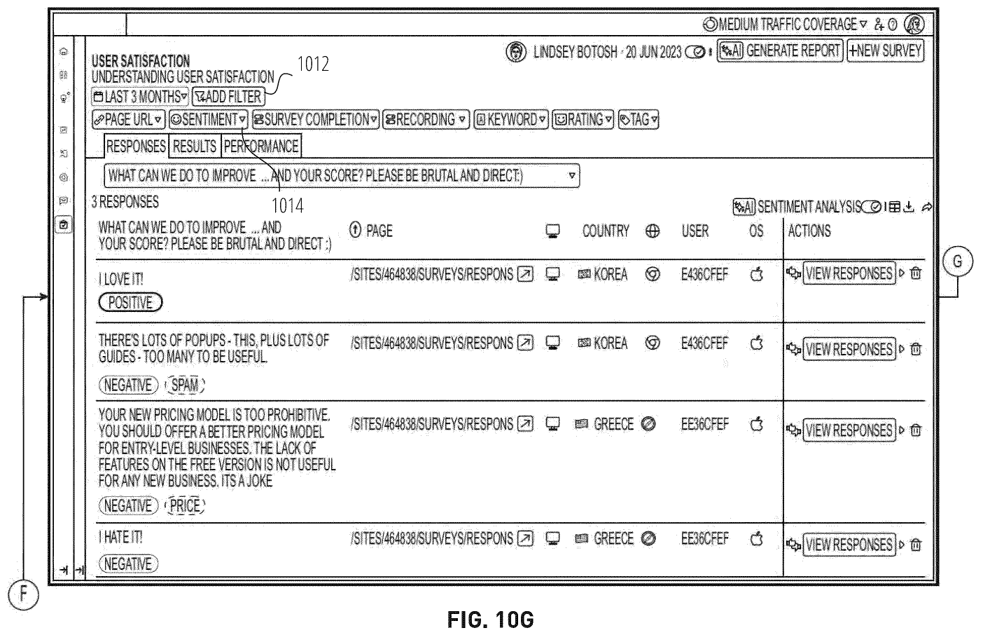

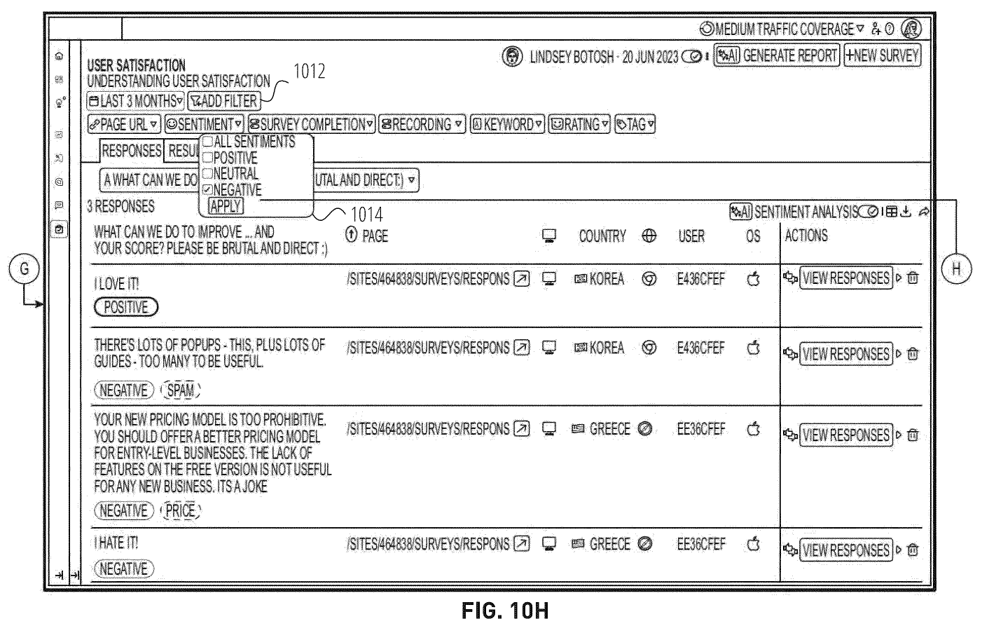

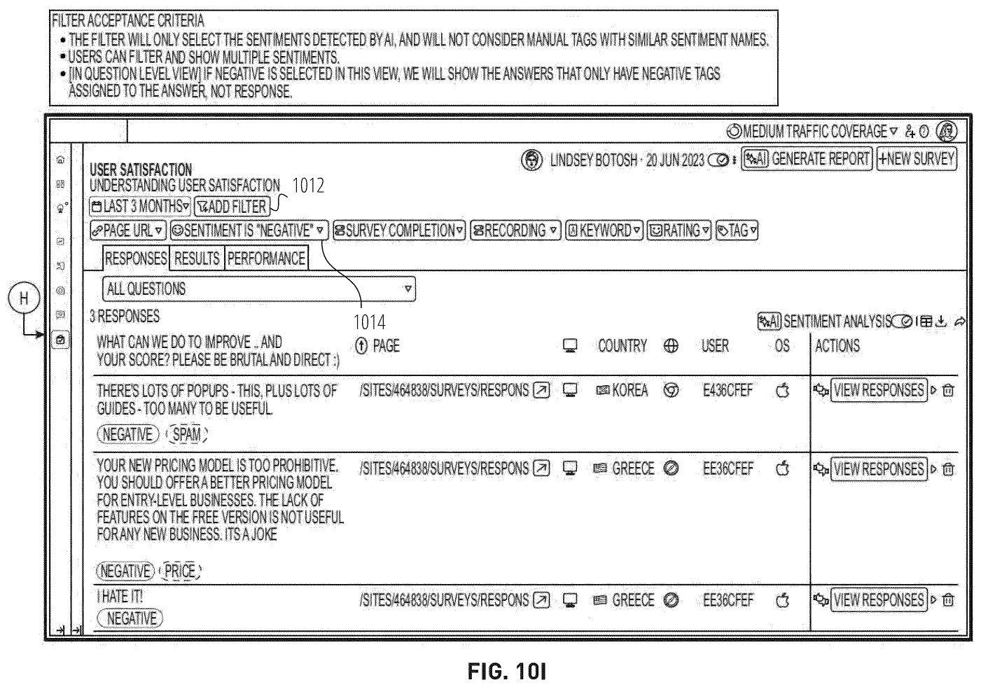

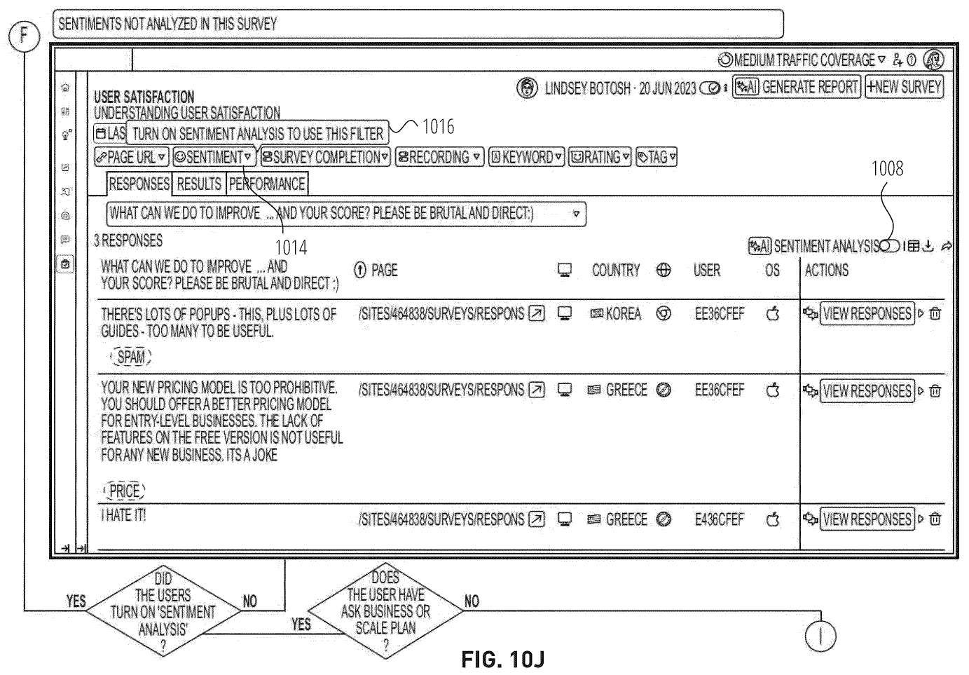

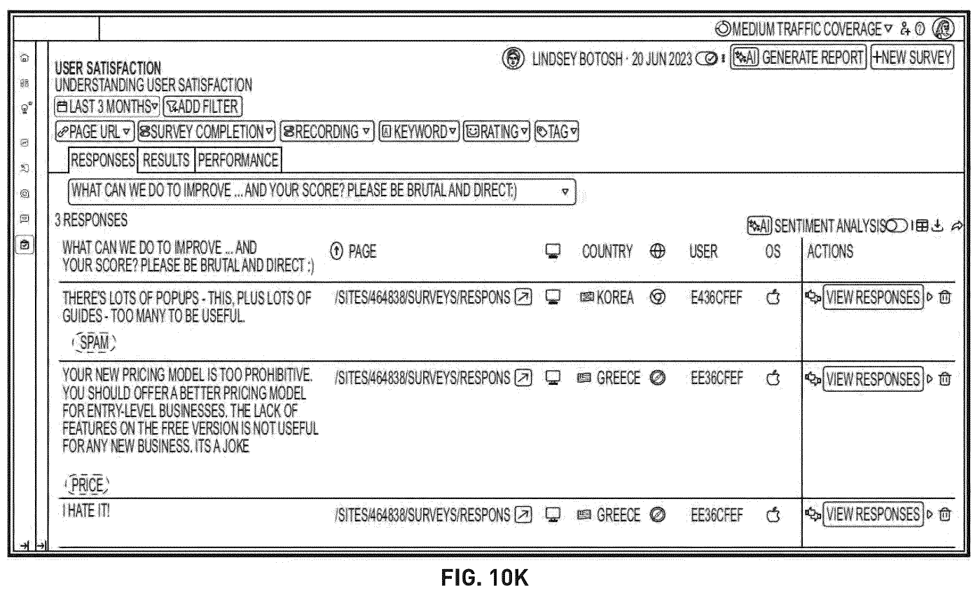

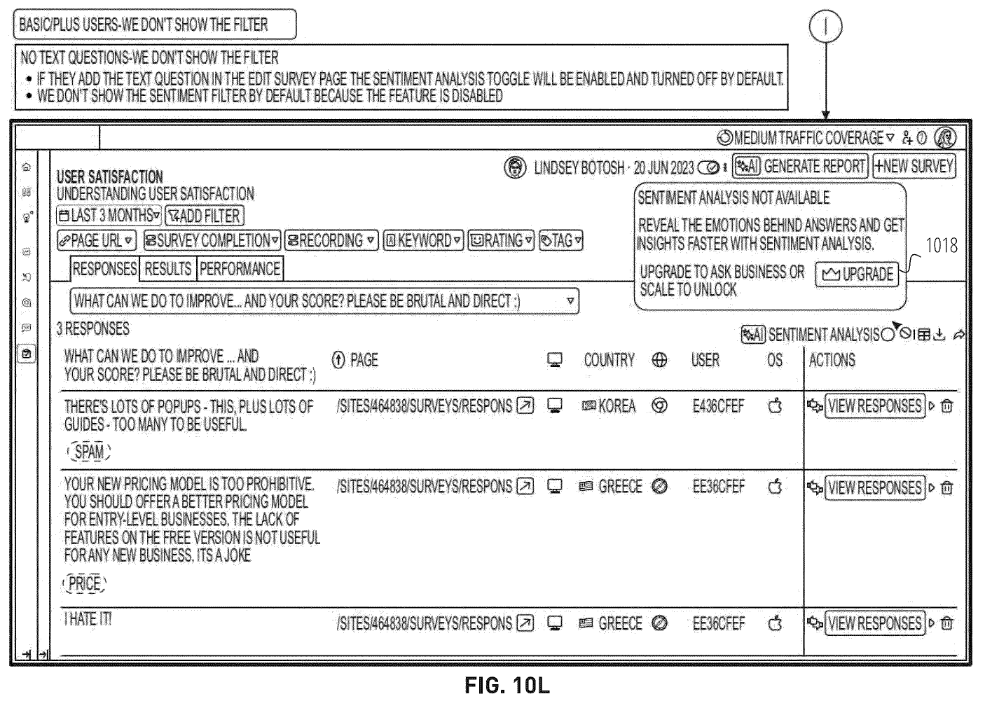

In the example of FIG. 6, the user interface flows 600-602 include decision blocks 604-610. In addition, the user interface flows 600-602 depicts blocks 10A-10L, which respectively correspond with the user interfaces of FIGS. 10A-10L. For explanatory purposes, the user interface flows 600-602 are primarily described herein with reference to the member client device 102, the customer client device 104 and the experience analytics server 122 of FIG. 1. However, one or more blocks (or operations) of the user interface flows 600-602 may be performed by one or more other components, and/or by other suitable devices. Further for explanatory purposes, the blocks (or operations) of the user interface flows 600-602 are described herein as occurring in serial, or linearly. However, multiple blocks (or operations) of the user interface flows 600-602 may occur in parallel or concurrently. In addition, the blocks (or operations) of the user interface flows 600-602 need not be performed in the order shown and/or one or more blocks (or operations) of the user interface flows 600-602 need not be performed and/or can be replaced by other operations. The user interface flows 600-602 may be terminated when its operations are completed. In addition, the user interface flows 600-602 may correspond to a method, a procedure, an algorithm, etc.

In the example of FIG. 6, the user interface flow 600 corresponds with applying filters with respect to all questions. At decision block 604, the sentiment system 408 determines whether a user at the member client device 102 has an ask business or scale plan (e.g., whether the user has subscribed/enrolled to the sentiment analysis feature offered by the experience analytics system 100).

If the user does have an ask business or scale plan, the sentiment system 408 proceeds to decision block 606. At decision block 606, the sentiment system 408 determines if the user turned sentiment analysis on. If the user turned on sentiment analysis, the sentiment system 408 presents the user interfaces of FIGS. 10A, 10B and 10C. As discussed further below, 10A, 10B and 10C relate to a user filtering by sentiment classification (e.g., positive, negative, neutral) for survey responses.

If the user did not turn sentiment analysis on per decision block 606, the sentiment system 408 presents the user interfaces of FIGS. 10D and 10E. As discussed further below, FIGS. 10D and 10E indicate that filtering is disabled but available by turning on sentiment analysis.

If the user does not have an ask business or scale plan per decision block 604, the sentiment system 408 proceeds with presenting the user interface of FIG. 10F. As discussed further below, FIG. 10F does not show filters for applying to sentiment analysis, and includes a user-selectable option for the user to subscribe or otherwise enroll to a business or scale plan for sentiment analysis.

In the example of FIG. 6, the user interface flow 602 corresponds with applying filters at the question level. At decision block 608, the sentiment system 408 determines whether a user at the member client device 102 has an ask business or scale plan (e.g., whether the user has subscribed/enrolled to the sentiment analysis feature offered by the experience analytics system 100).

If the user does have an ask business or scale plan, the sentiment system 408 proceeds to decision block 610. At decision block 610, the sentiment system 408 determines if the user turned sentiment analysis on. If the user turned sentiment analysis on, the sentiment system 408 presents the user interfaces of FIGS. 10G, 10H and 10I. As discussed further below, 10G, 10H and 10I relate to a user filtering by sentiment classification (e.g., positive, negative, neutral) for survey responses.

If the user did not turn sentiment analysis on per decision block 610, the sentiment system 408 presents the user interfaces of FIGS. 10J and 10K. As discussed further below, 10J and 10K indicate that filtering is disabled but available by turning on sentiment analysis.

If the user does not have an ask business or scale plan per decision block 608, the sentiment system 408 proceeds with presenting the user interface of FIG. 10L. As discussed further below, FIG. 10L does not show filters for applying to sentiment analysis, and includes a user-selectable option for the user to subscribe or otherwise enroll to a business or scale plan for sentiment analysis.

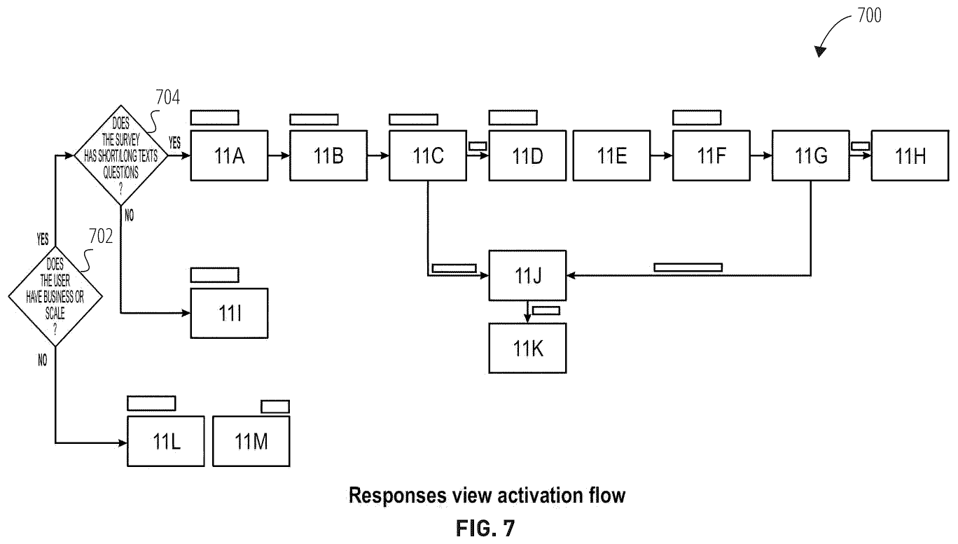

FIG. 7 illustrates a user interface flow 700 for enabling sentiment analysis for survey responses, in accordance with some examples. As noted above, the sentiment system 408 is configured to activate/disable various fields for viewing by the user.

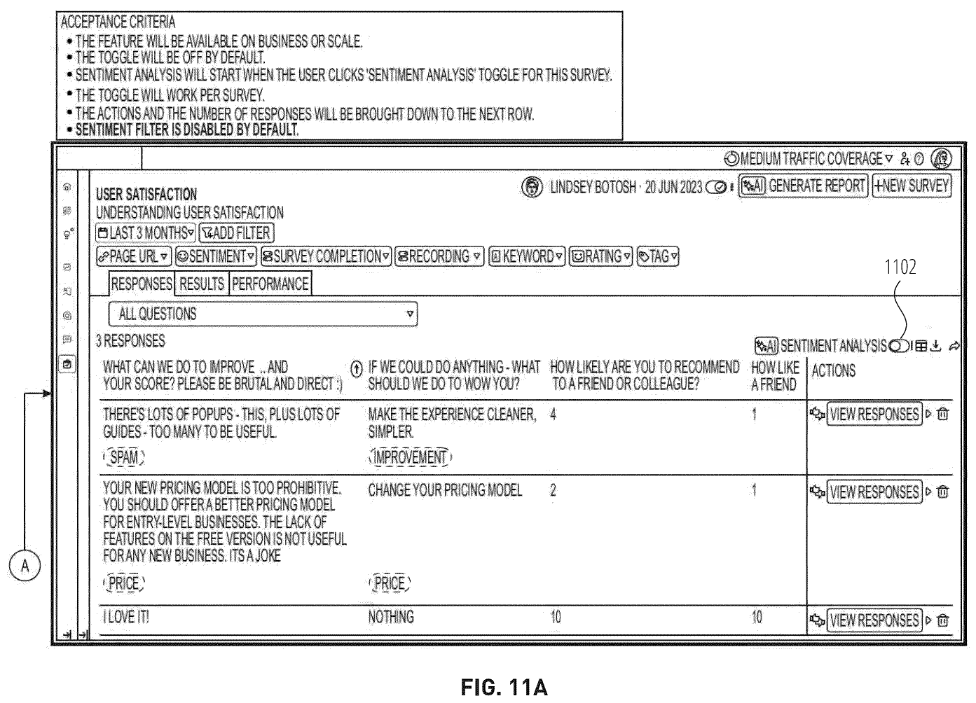

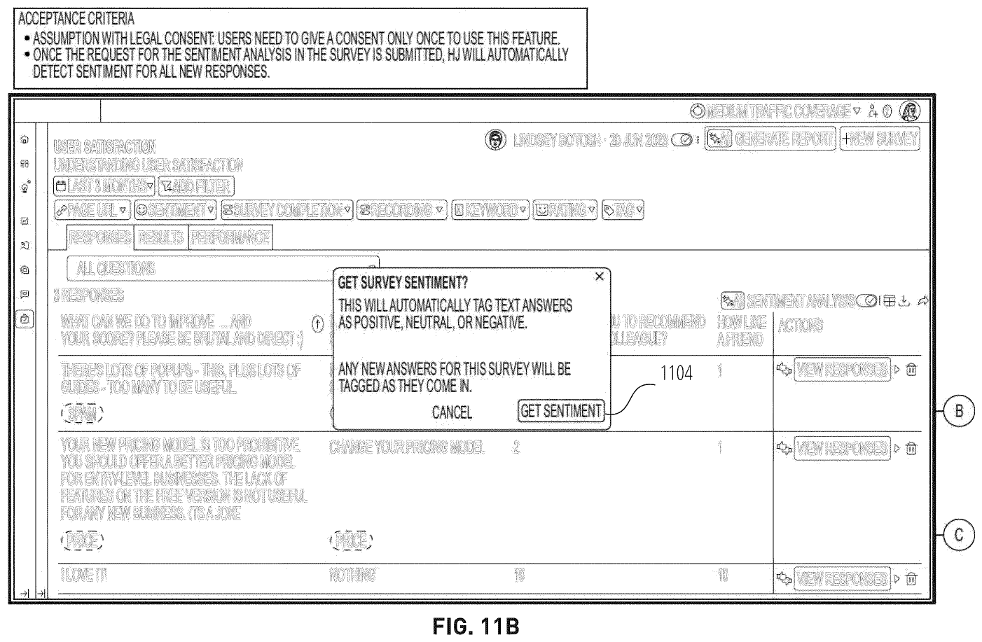

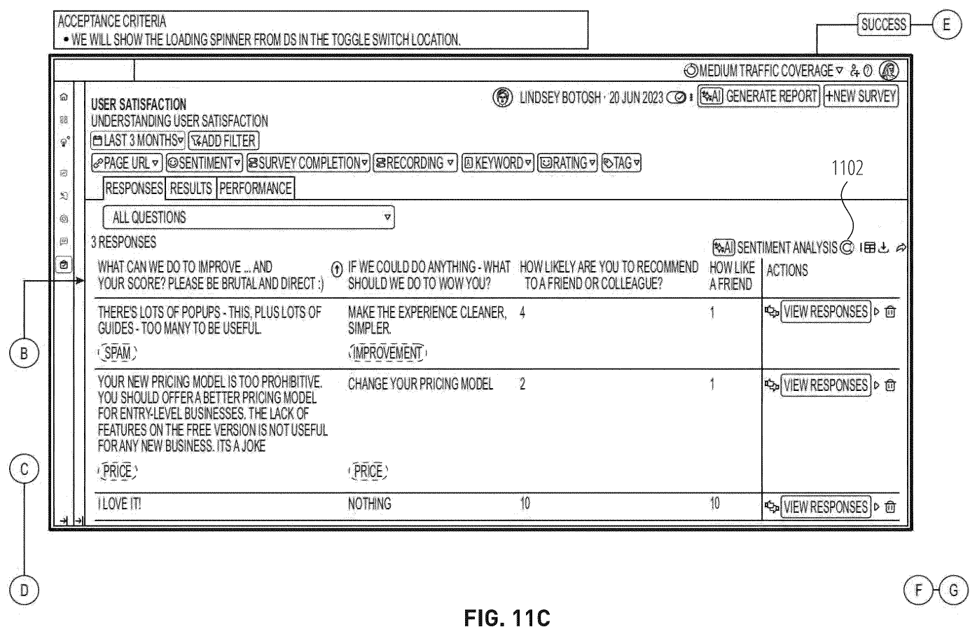

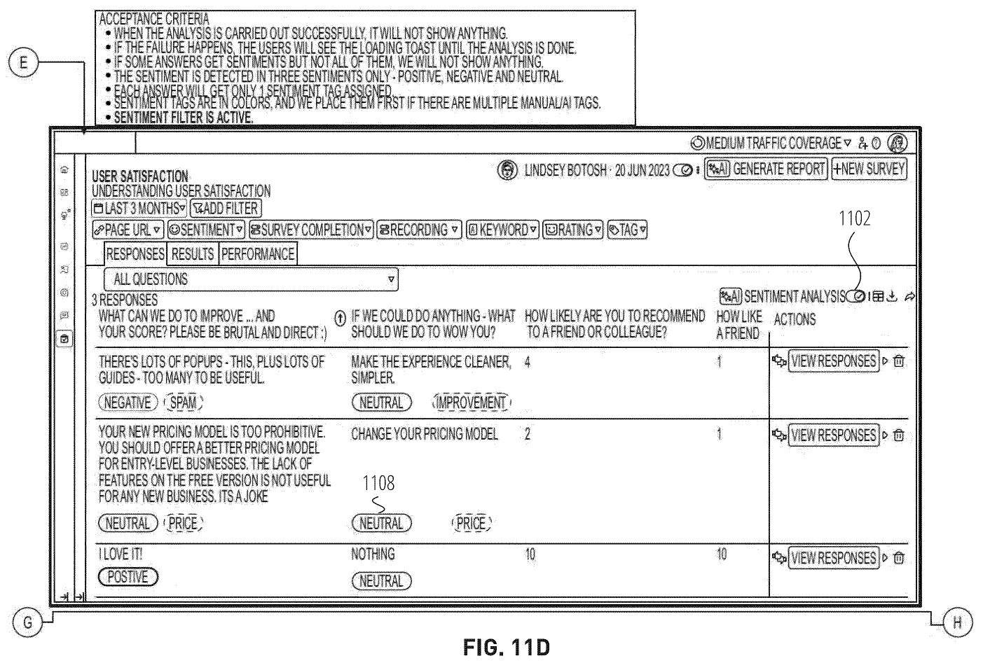

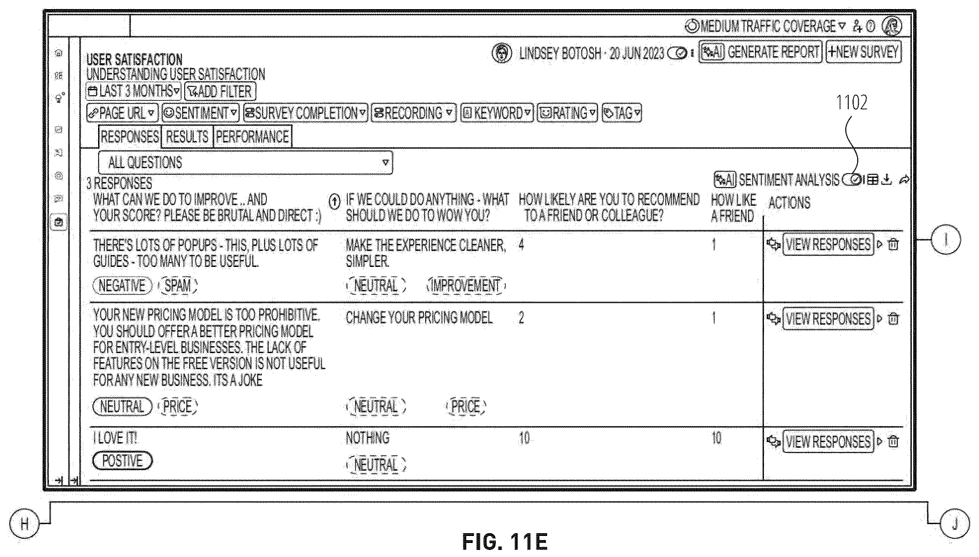

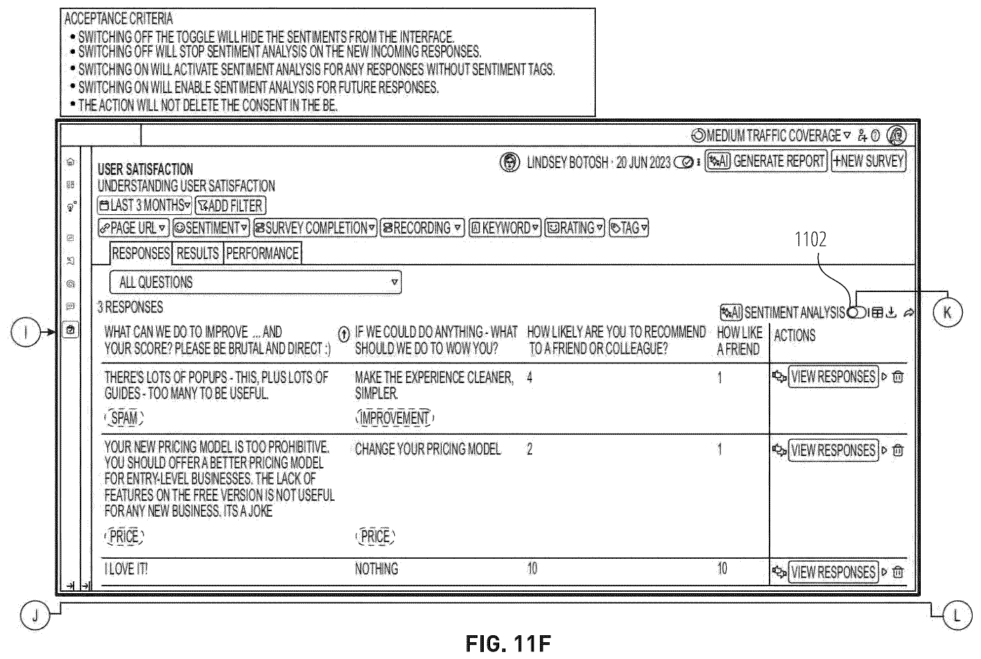

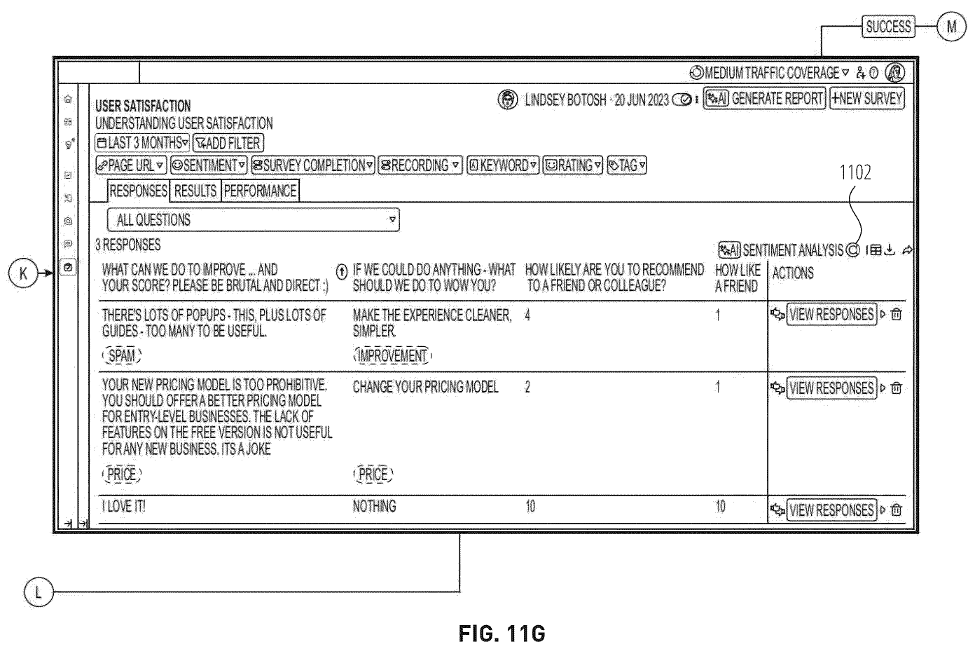

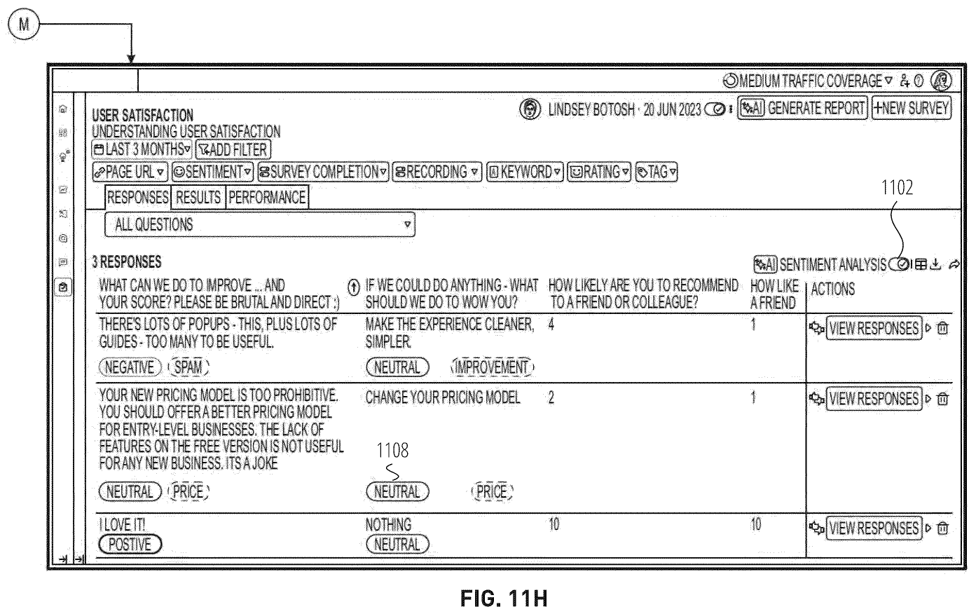

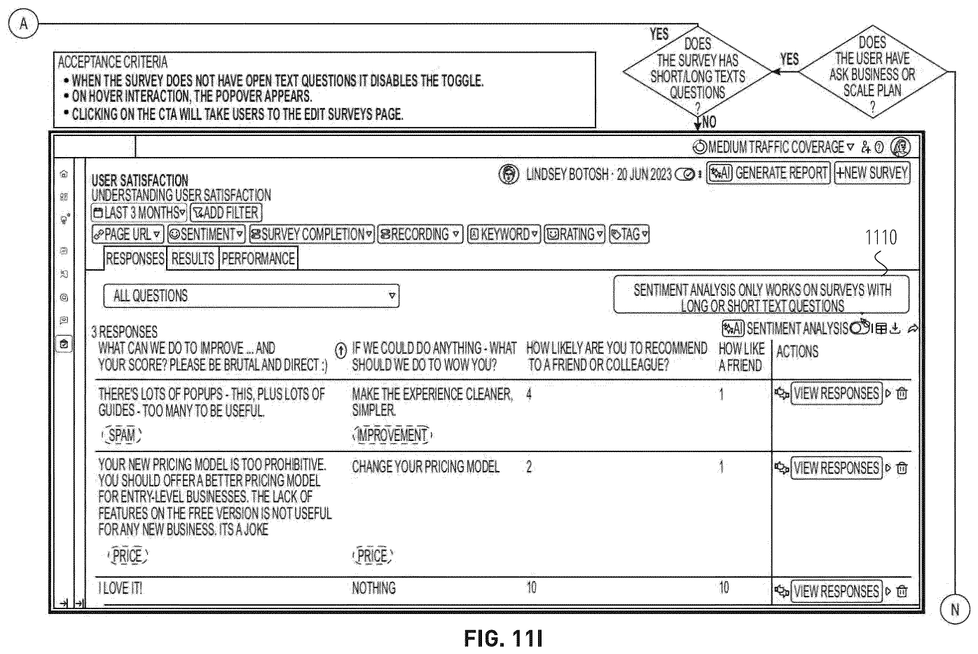

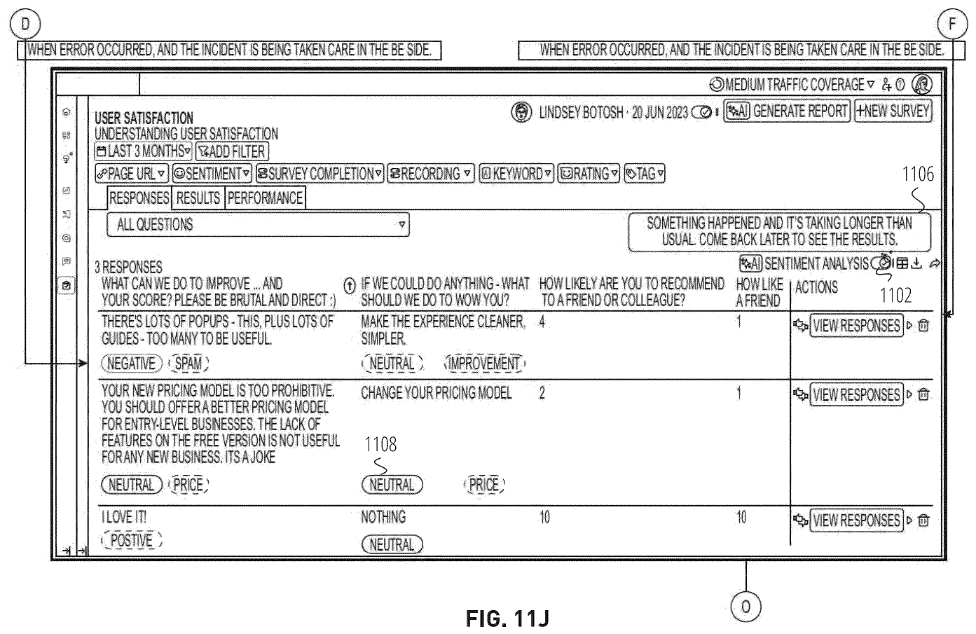

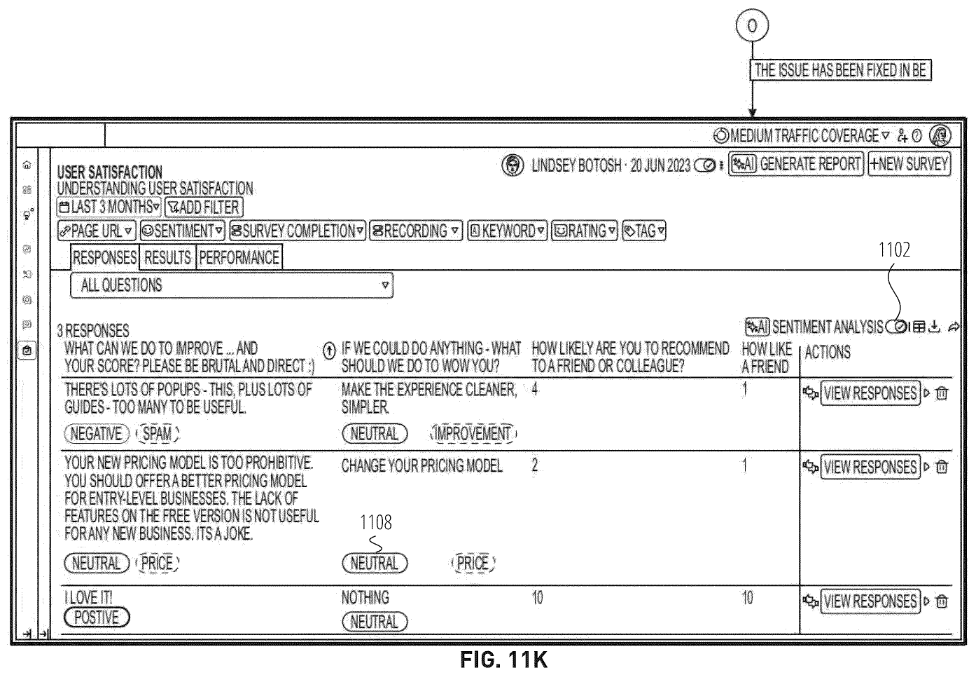

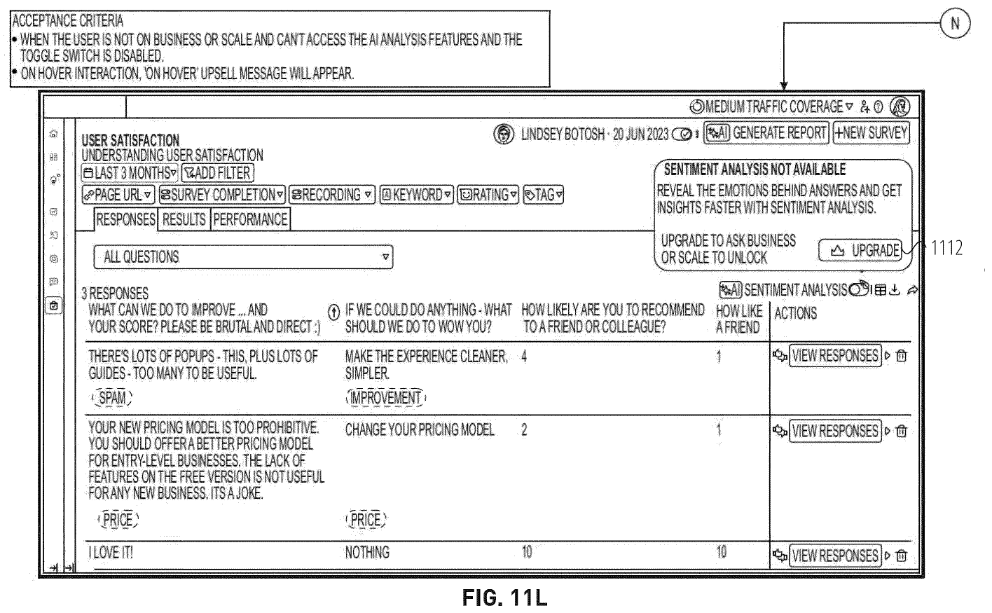

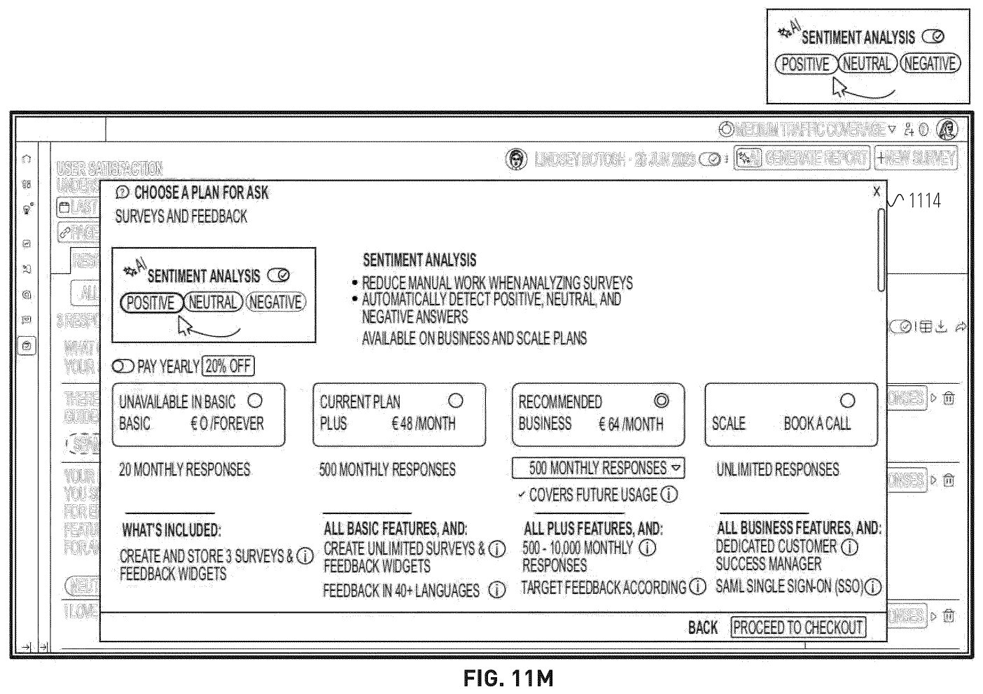

In the example of FIG. 7, the user interface flow 700 includes decision blocks 702-704. In addition, the user interface flow 700 depicts blocks 11A-11M, which respectively correspond with the user interfaces of FIGS. 11A-11M. For explanatory purposes, the user interface flow 700 is primarily described herein with reference to the member client device 102, the customer client device 104 and the experience analytics server 122 of FIG. 1. However, one or more blocks (or operations) of the user interface flow 700 may be performed by one or more other components, and/or by other suitable devices. Further for explanatory purposes, the blocks (or operations) of the user interface flow 700 are described herein as occurring in serial, or linearly. However, multiple blocks (or operations) of the user interface flow 700 may occur in parallel or concurrently. In addition, the blocks (or operations) of the user interface flow 700 need not be performed in the order shown and/or one or more blocks (or operations) of the user interface flow 700 need not be performed and/or can be replaced by other operations. The user interface flow 700 may be terminated when its operations are completed. In addition, the user interface flow 700 may correspond to a method, a procedure, an algorithm, etc.

At decision block 702, the sentiment system 408 determines whether a user at the member client device 102 has an ask business or scale plan (e.g., whether the user has subscribed/enrolled to the sentiment analysis feature offered by the experience analytics system 100).

If the user does have an ask business or scale plan, the sentiment system 408 proceeds to decision block 704. At decision block 704, the sentiment system 408 determines if the survey has short/long text questions. If the survey has short/long text questions, the sentiment system 408 presents the user interfaces of FIGS. 11A-11H and 11J-11K. As discussed further below, 11A-11H and 11J-11K relate to enabling sentiment analysis, and the processing time associated therewith.

If the survey does not have short/long text questions per decision block 704, the sentiment system 408 presents the user interface of FIG. 11I. As discussed further below, FIG. 11I indicates that sentiment analysis only works with text questions (e.g., long or short).

If the user does not have an ask business or scale plan per decision block 702, the sentiment system 408 proceeds with presenting the user interfaces of FIGS. 11L and 11M. As discussed further below, FIGS. 11L and 11M indicate that sentiment analysis is disabled, and includes a user-selectable option for the user to subscribe or otherwise enroll to a business or scale plan for enabling sentiment analysis.

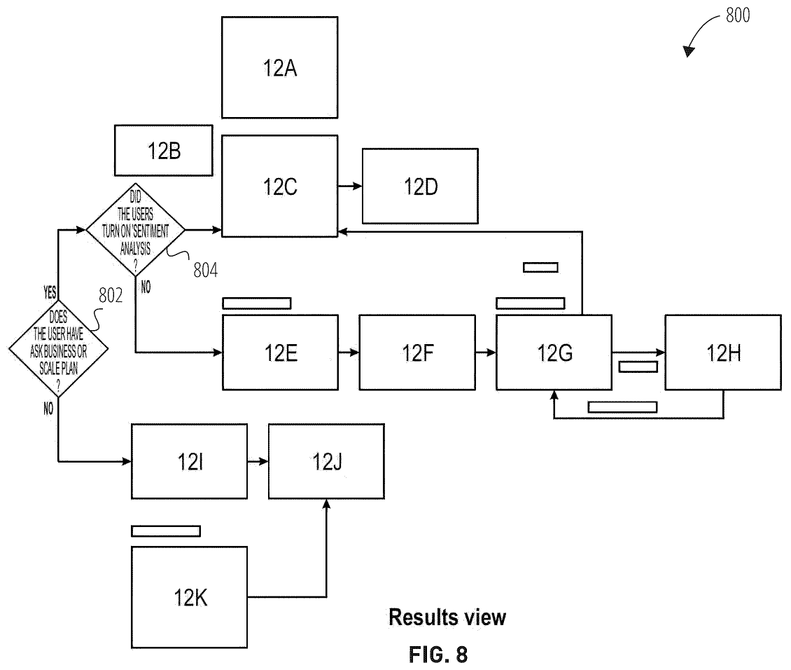

FIG. 8 illustrates a user interface flow 800 for viewing results with respect to performing sentiment analysis for survey responses, in accordance with some examples. As noted above, the sentiment system 408 is configured to display graphs and metrics corresponding to sentiment results/metrics.

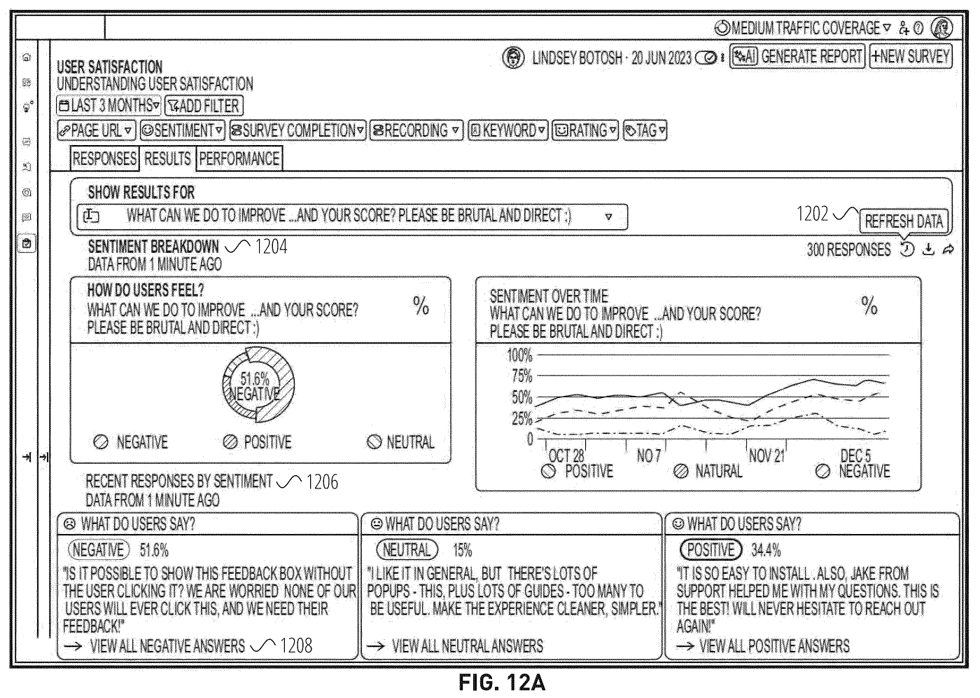

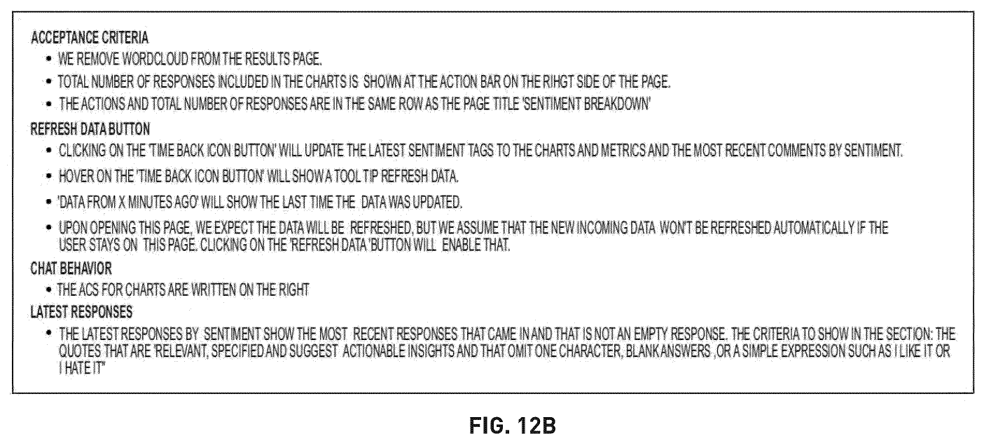

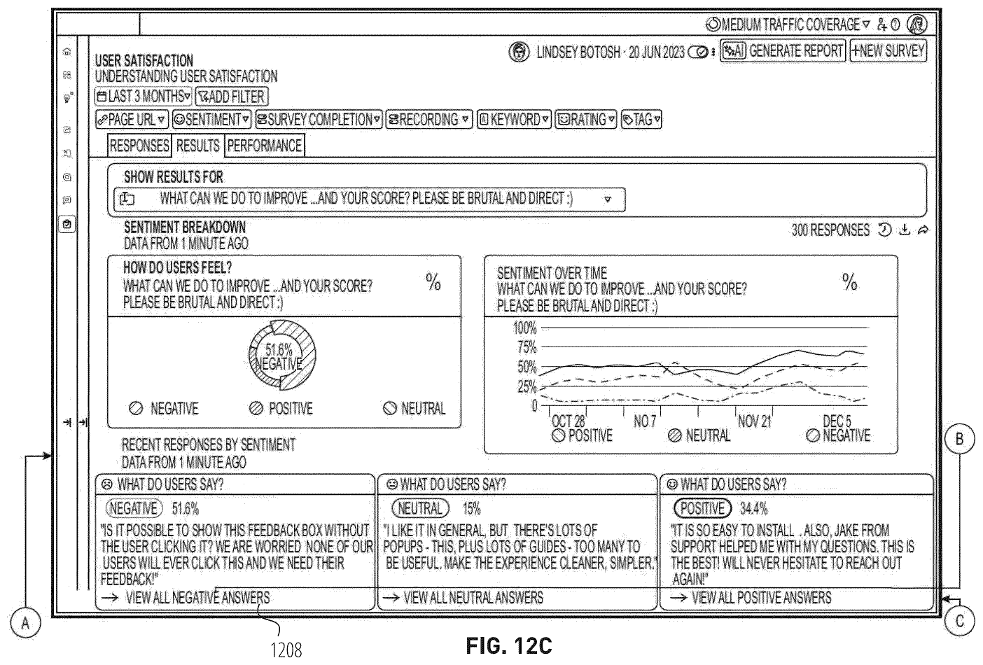

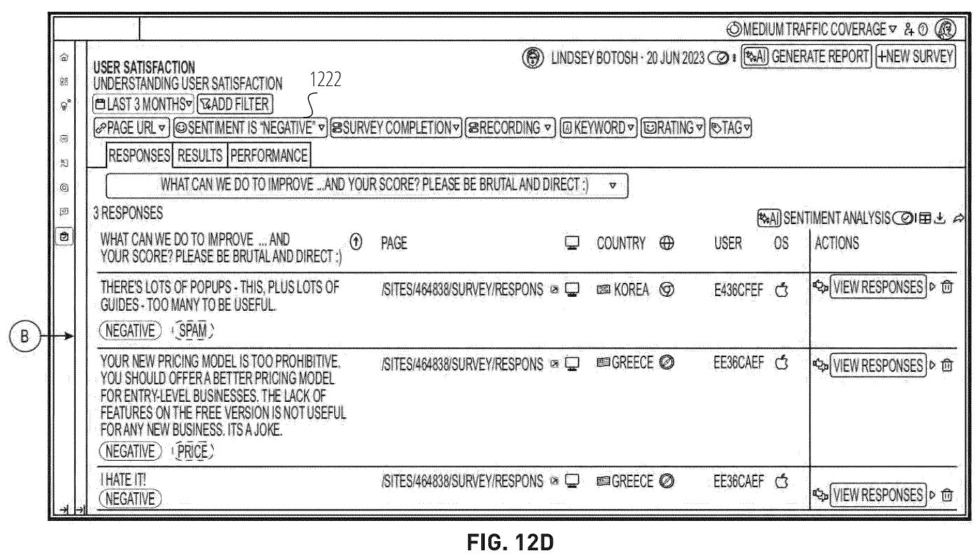

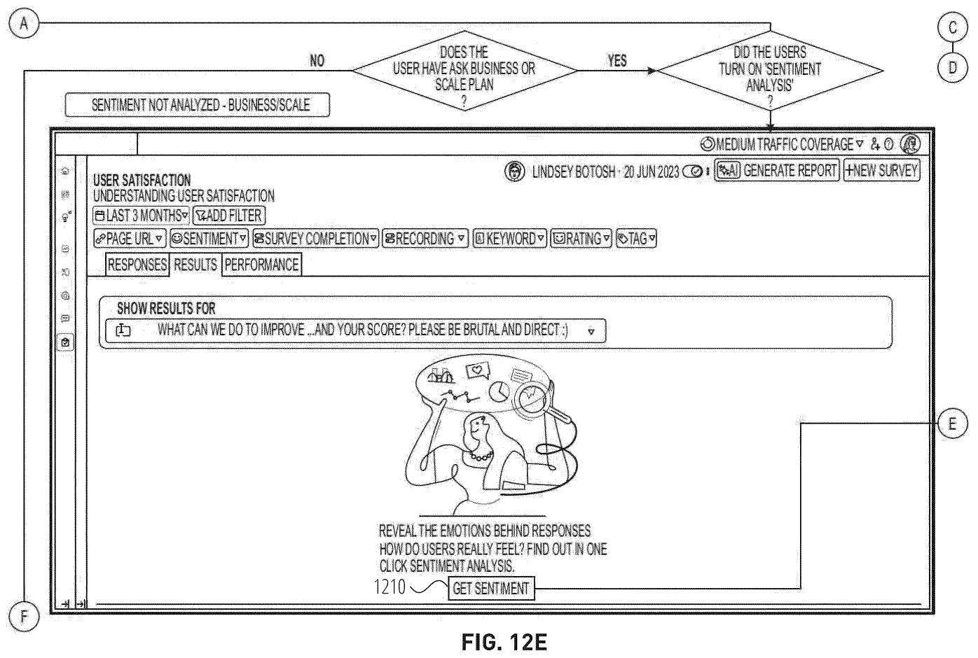

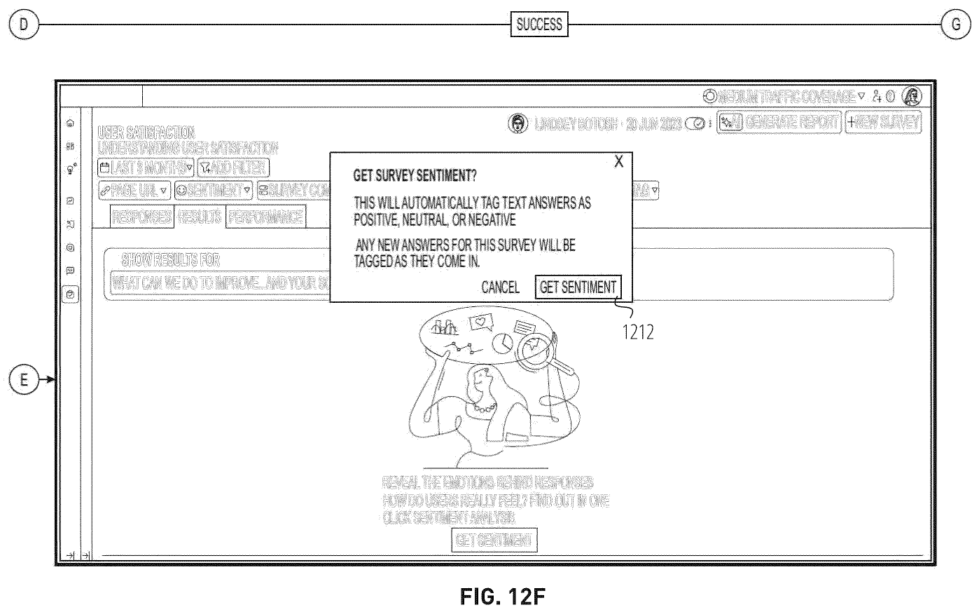

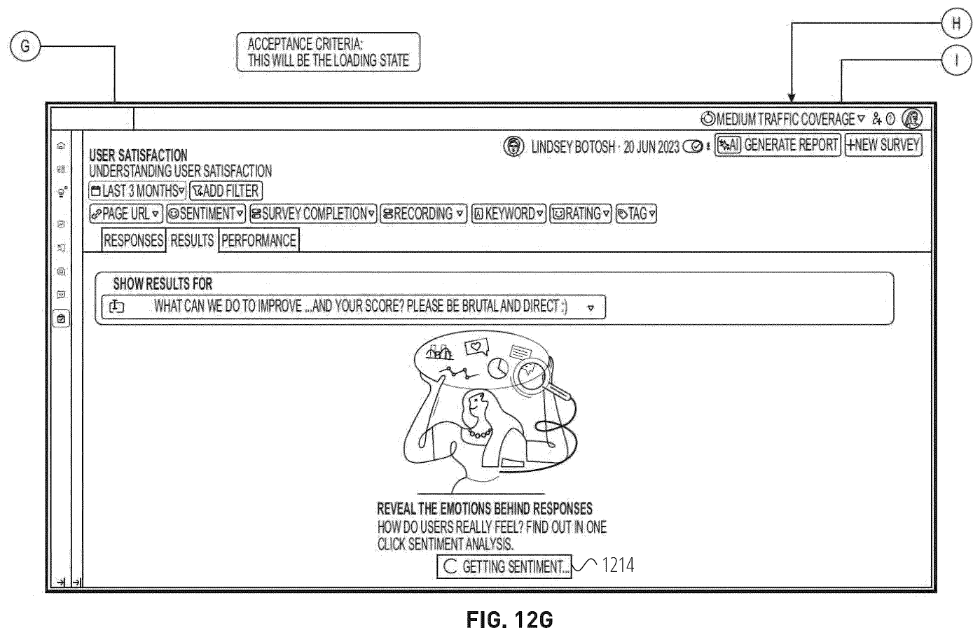

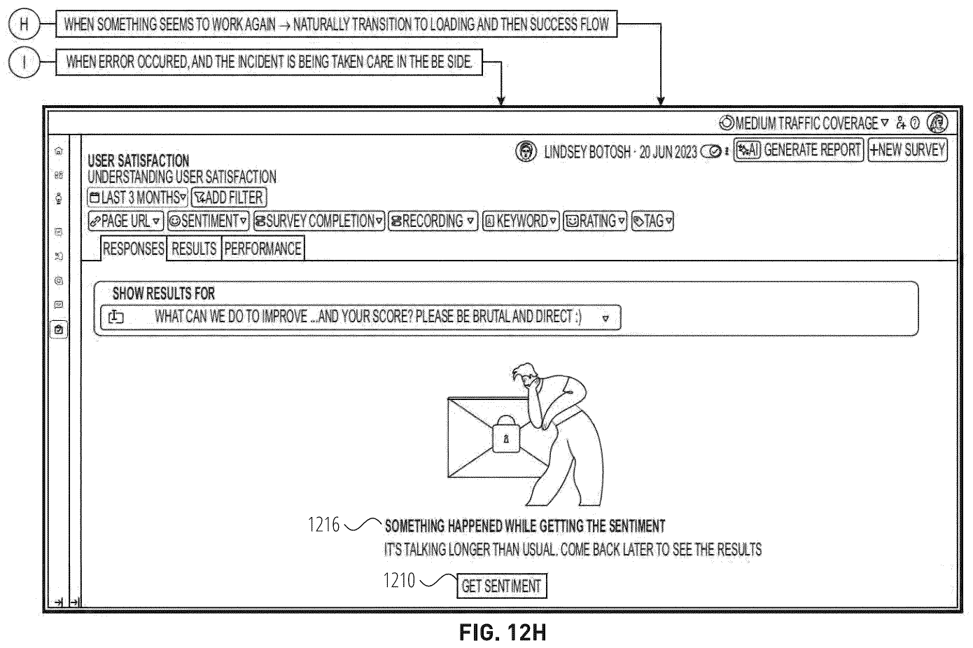

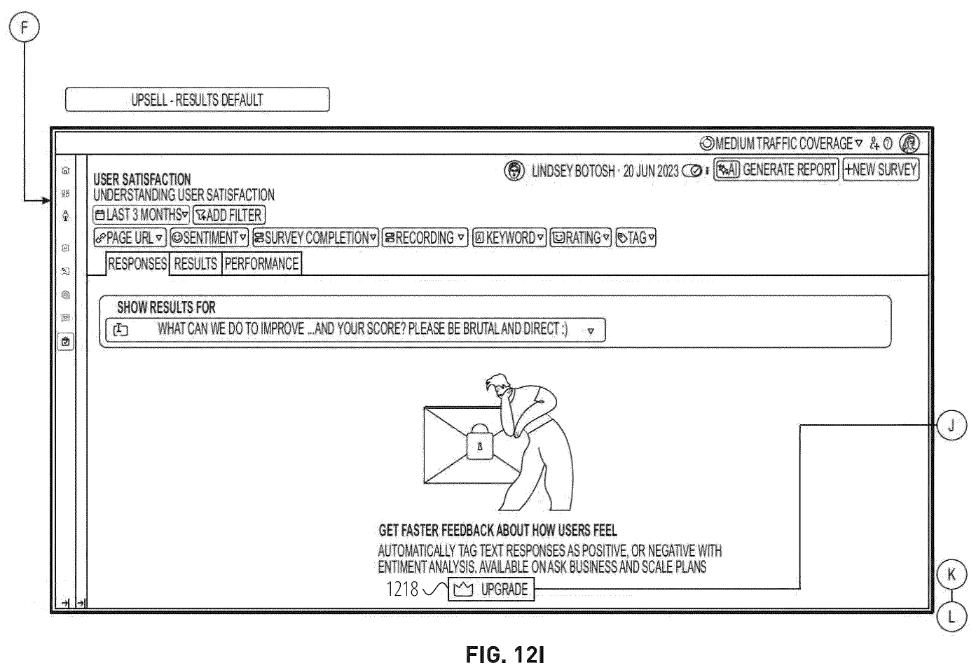

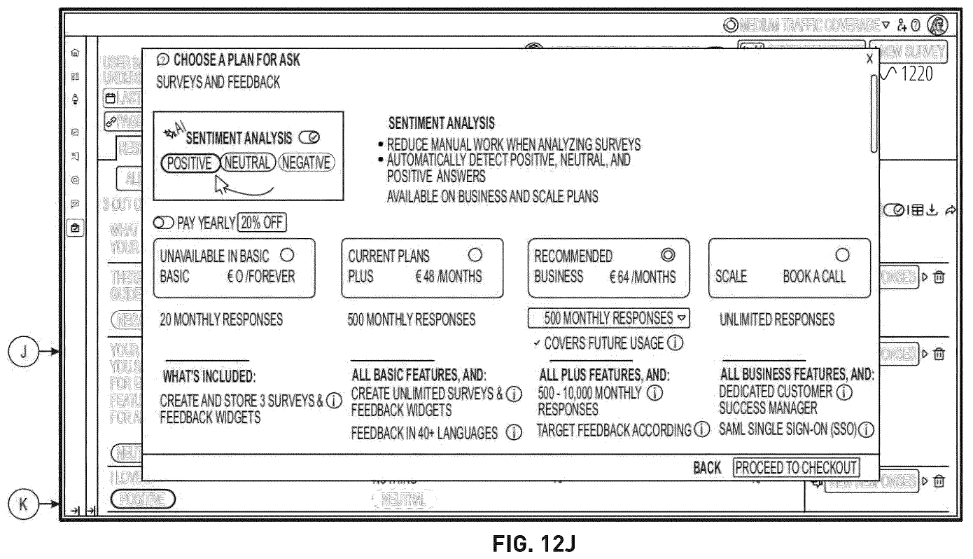

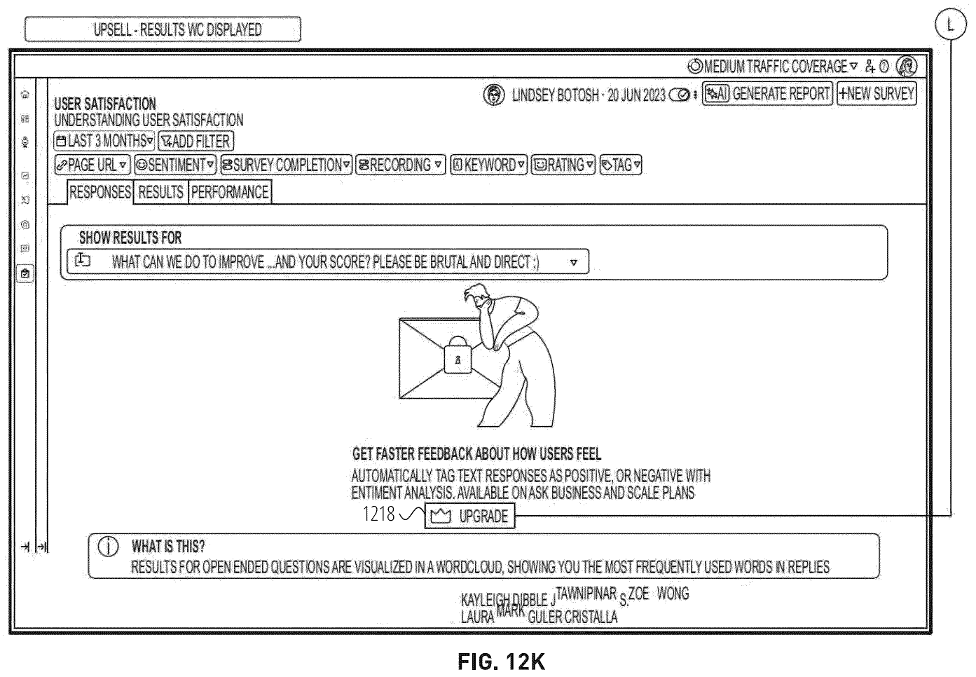

In the example of FIG. 8, the user interface flow 800 includes decision blocks 802-804. In addition, the user interface flow 800 depicts blocks 12A-12K, which respectively correspond with the user interfaces of FIGS. 12A-12K. For explanatory purposes, the user interface flow 800 is primarily described herein with reference to the member client device 102, the customer client device 104 and the experience analytics server 122 of FIG. 1.

However, one or more blocks (or operations) of the user interface flow 800 may be performed by one or more other components, and/or by other suitable devices. Further for explanatory purposes, the blocks (or operations) of the user interface flow 800 are described herein as occurring in serial, or linearly. However, multiple blocks (or operations) of the user interface flow 800 may occur in parallel or concurrently. In addition, the blocks (or operations) of the user interface flow 800 need not be performed in the order shown and/or one or more blocks (or operations) of the user interface flow 800 need not be performed and/or can be replaced by other operations. The user interface flow 800 may be terminated when its operations are completed. In addition, the user interface flow 800 may correspond to a method, a procedure, an algorithm, etc.

At decision block 802, the sentiment system 408 determines whether a user at the member client device 102 has an ask business or scale plan (e.g., whether the user has subscribed/enrolled to the sentiment analysis feature offered by the experience analytics system 100).

If the user does have an ask business or scale plan, the sentiment system 408 proceeds to decision block 804. At decision block 804, the sentiment system 408 determines if the user turned sentiment analysis on. If the user turned on sentiment analysis, the sentiment system 408 presents the user interfaces of FIGS. 12A-12D. As discussed further below, 12A-12D relate to viewing results (e.g., reports, metrics) for sentiment analysis.

If the user did not turn sentiment analysis on per decision block 804, the sentiment system 408 presents the user interfaces of 12E-12H. As discussed further below, FIGS. 12E-12H indicate that viewing results is disabled, and provides for the user to enable the viewing of results per FIGS. 12A-12D.

If the user does not have an ask business or scale plan per decision block 802, the sentiment system 408 proceeds with presenting the user interfaces of FIGS. 12I-12K. As discussed further below, 12I-12K do not show results for sentiment analysis, and include a user-selectable option for the user to subscribe or otherwise enroll to a business or scale plan for sentiment analysis.

FIGS. 9A-9O illustrate various user interfaces related to editing sentiment tags per FIG. 5, in accordance with some examples. As shown in FIGS. 9A-9O, sentiment system 408 provides for the user at member client device 102, via the sentiment user interface 404, to edit sentiment tags as presented in the sentiment user interface 404. The sentiment system 408 is configured to update the feedback table 316 of the database 300 based on the edited sentiment tags, such that the sentiment user interface 404 is updated to display the sentiment tags as edited.

As noted above with respect to FIG. 5, FIGS. 9N and 9O are presented in a case where the user does not have an ask business or scale plan. The example of FIG. 9N includes a button 902 which is user selectable to surface an overlay 904 as shown in FIG. 9O. The overlay 904 includes user-selectable options for the user to subscribe or otherwise enroll in a business or scale plan for sentiment analysis.

As noted above, FIG. 9K is presented in a case where sentiment analysis is turned off, and the survey has text questions. FIG. 9K includes a toggle 906 and a notification 908 indicating that sentiment analysis is turned off. The toggle 906 is selectable to turn sentiment analysis on. Moreover, FIG. 9M is presented in a case where sentiment analysis is turned off, and the survey does not have text questions. FIG. 9M includes the toggle 906, and a notification 910 indicating that sentiment analysis is disabled and available for surveys with long or short text questions.

FIG. 9B is presented in a case where sentiment analysis is turned on. FIG. 9B includes the toggle 906, which indicates that sentiment analysis is enabled. As shown in FIG. 9B, each question-response pair includes a sentiment tag (e.g., sentiment classification) as interpreted by the sentiment system 408. The sentiment tags are editable by the user, for example, in response to a hover gesture by the user. In the example of FIG. 9B, the user performs a hover gesture with respect to sentiment tag 912. In response, the sentiment system 408 provides a remove element (e.g., an “x” icon) which is user-selectable to remove the sentiment tag 912 as shown in FIG. 9C.

As noted above, FIG. 9A is presented in a case where user editing (e.g., removal of the sentiment tag 912) is unsuccessful. FIG. 9A displays an error 914 occurred with respect to editing/removing the sentiment tag 912. On the other hand, FIGS. 9D, 9E and 9F are presented in a case where the user editing (e.g., removal of the sentiment tag 912) is successful. FIG. 9D illustrates that the sentiment tag 912 (e.g., the “neutral” tag) was removed, and FIG. 9E illustrates a hover gesture 916 performed with respect to the corresponding text.

In response, FIG. 9F is presented and includes an interface with buttons (e.g., including button 918) for adding a new sentiment tag in place of the removed sentiment tag 912. FIG. 9G is presented in a case where adding the new sentiment tag is successful. FIG. 9G includes a new sentiment tag 920 with “neutral” sentiment. On the other hand, FIG. 9J is presented in a case where the adding the new sentiment tag is unsuccessful, and includes a corresponding error 922.

FIG. 9H is presented in a case where the user selects to update/replace the value for the sentiment tag 912 (e.g., as compared to deleting the prior sentiment tag 912 and adding a new sentiment tag 920). Thus, FIG. 9H includes a dropdown menu 924 with the unselected tags (e.g., positive, neutral) as options. In the example of FIG. 9H, the user selects the positive sentiment from the dropdown menu 924. FIG. 9I is presented in a case where the replacement of the value for sentiment tag 912 is successful, as indicated by the positive value for sentiment tag 912. On the other hand, FIG. 9L is presented in a case where replacing the value is unsuccessful, and includes a corresponding error 926.

FIGS. 10A-10L illustrate various user interfaces related to applying filters per FIG. 6, in accordance with some examples. As shown in the example of FIGS. 10A-10L, the user is permitted to drill down into survey responses, and to view corresponding sentiments (e.g., as filtered).

As noted above with respect to FIG. 6, FIGS. 10A, 10B and 10C are presented in a case where the user turned on sentiment analysis. The example of FIG. 10A includes a filter button 1002 for adding filters, and further includes a sentiment filter 1004 which is user-selectable to filter by sentiment classification (e.g., sentiment flag). FIG. 10B illustrates that the user selected the filter button 1002 to add a filter, and selected to filter by negative sentiment via the sentiment filter 1004. Moreover, FIG. 10C shows the results of filtering based on the user selection via the sentiment filter 1004 (e.g., filtering by negative sentiment).

FIGS. 10D and 10E are presented in a case where the user did not turn sentiment analysis on. In FIG. 10D, the sentiment filter 1004 is disabled (e.g., grayed out). In addition, FIG. 10D includes a notification 1006 instructing the user to enable sentiment analysis (e.g., via the toggle 1008) in order to enable the sentiment filter 1004. FIG. 10E illustrates an example where the survey does not have text questions and as such, the sentiment filter 1004 and the notification 1006 are not presented.

FIG. 10F is presented in a case where the user does not have an ask business or scale plan. FIG. 10F does not show filters for applying to sentiment analysis, and includes a user-selectable button 1010 for the user to subscribe or otherwise enroll to a business or scale plan for sentiment analysis.

As noted above with respect to FIG. 6, FIGS. 10G, 10H and 10I are presented in a case where the user turned on sentiment analysis. The example of FIG. 10G includes a filter button 1012 for adding filters, and further includes a sentiment filter 1014 which is user-selectable to filter by sentiment classification (e.g., sentiment flag). FIG. 10H illustrates that the user selected the filter button 1012 to add a filter, and selected to filter by negative sentiment via the sentiment filter 1014. Moreover, FIG. 10I shows the results of filtering based on the user selection via the sentiment filter 1014 (e.g., filtering by negative sentiment).

FIGS. 10J and 10K are presented in a case where the user did not turn sentiment analysis on. In FIG. 10J, the sentiment filter 1014 is disabled (e.g., grayed out). In addition, FIG. 10D includes a notification 1016 instructing the user to enable sentiment analysis (e.g., via the 1018) in order to enable the sentiment filter 1014. FIG. 10K illustrates an example where the survey does not have text questions and as such, the sentiment filter 1014 and the notification 1016 are not presented.

FIG. 10L is presented in a case where the user does not have an ask business or scale plan. FIG. 10L does not show filters for applying to sentiment analysis, and includes a user-selectable button 1018 for the user to subscribe or otherwise enroll to a business or scale plan for sentiment analysis.

FIGS. 11A-11M illustrate various user interfaces related to the enabling of sentiment analysis in FIG. 7, in accordance with some examples. For example, FIGS. 11A-11M depicts various views that can be toggled on/off for improved readability, efficiency, and the like.

As noted above with respect to FIG. 7, FIGS. 11A-11H and 11J-11K are presented in a case where the user turned on sentiment analysis. 11A-11H and 11J-11K relate to enabling sentiment analysis, and the processing time associated therewith. The example of FIG. 11A illustrates that a toggle 1102 for enabling sentiment analysis, on a per survey basis, is disabled by default. FIG. 11B is presented in response to user selection of the toggle 1102, and includes an overlay with a button 1104 to confirm enabling of sentiment analysis.

In response to the user selecting the button 1104, FIG. 11C provides an animation for the toggle 1102 indicating progress with respect to the processing for sentiment analysis. FIGS. 11D-11E show that such processing is complete via the enabled state of the toggle 1102 and sentiment tags (e.g., including sentiment tag 1108) for the survey. FIG. 11F shows a case where the user then selects to disable sentiment analysis via the toggle 1102, which reverts to the disabled state with the sentiment tags (e.g., sentiment tag 1108) removed. If the user selects toggle 1102 again, FIG. 11G illustrates the toggle 1102 with the animation for processing, and FIG. 11H illustrates the toggle 1102 with sentiment analysis enabled and the sentiment tags (e.g., sentiment tag 1108).

FIG. 11J illustrates a scenario in which an error occurs, and includes a notification 1106 indicating the processing time for performing the sentiment analysis is longer than usual. After the extended time, FIG. 11K is presented to indicate completion of the processing, and depicts the toggle 1102 with sentiment analysis enabled and the sentiment tags (e.g., sentiment tag 1108).

FIG. 11I is presented in a case where the survey does not have short/long text questions. FIG. 11I includes a notification 1110 indicating that sentiment analysis only works on surveys with long or short text questions.

FIG. 11L is presented in a case where the user does not have an ask business or scale plan. FIG. 11L does not have sentiment analysis available (e.g., via the toggle 1102), and includes a user-selectable button 1112 for the user to subscribe or otherwise enroll to a business or scale plan for sentiment analysis. In response to user selection of the button 1112, FIG. 11M is presented with an overlay 1114 which includes user-selectable options for the user to subscribe or otherwise enroll in a business or scale plan for sentiment analysis.

FIGS. 12A-12K illustrate various user interfaces related to the results view of FIG. 8, in accordance with some examples. In the example of FIGS. 12A-12K, the graphs and other result view depict trends of sentiment classifications over time.

As noted above with respect to FIG. 8, FIGS. 12A-12D are presented in a case where the user turned on sentiment analysis. FIGS. 12A-12D relate to viewing results (e.g., reports, metrics) for sentiment analysis. FIG. 12B corresponds to a dialog that provides description for FIG. 12A. FIG. 12A includes a sentiment breakdown section 1204 with breakdowns of “how do users feel?” and “sentiment over time.” FIG. 12A further includes a recent responses section 1206 with buttons of preselected filters (e.g., preselected filter 1208). The header for each of the sentiment breakdown section 1204 and recent responses section 1206 indicates a last refresh time (e.g., “data from 1 minute ago”). In this regard, FIG. 12A further includes a button 1202 which is user-selectable to refresh the data. In the example of FIG. 12C, the user selects the preselected filter 1208 which redirects to the user interface of FIG. 12D. FIG. 12D shows sentiment tags filtered by negative sentiment per sentiment filter 1222 (e.g., similar to FIG. 10C above).

FIGS. 12E-12H are presented in a case where the user did not turn sentiment analysis on. FIG. 12E includes a button 1210 which is user selectable to enable sentiment analysis. In response to selection of button 1210, FIG. 12F is presented including an overlay with a button 1212 to confirm enabling sentiment analysis. FIG. 12G includes a progress indicator 1214 to indicate processing time with respect to viewing results, and FIG. 12H includes an error 1216 in a case where an error with such processing occurs.

FIG. 12I is presented in a case where the user does not have an ask business or scale plan. Each of FIG. 12I and FIG. 12K includes a user-selectable button 1218 for the user to subscribe or otherwise enroll to a business or scale plan for sentiment analysis. In response to user selection of the button 1218, FIG. 12J is presented with an overlay 1220 which includes user-selectable options for the user to subscribe or otherwise enroll in a business or scale plan for sentiment analysis.

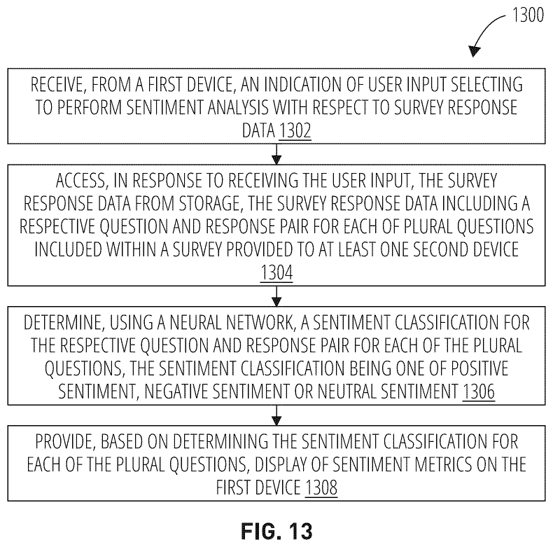

FIG. 13 is a flowchart illustrating a process 1300 for performing sentiment analysis for survey responses, in accordance with some examples. For explanatory purposes, the process 1300 is primarily described herein with reference to the member client device 102, the customer client device 104 and the experience analytics server 122 of FIG. 1. However, one or more blocks (or operations) of the process 1300 may be performed by one or more other components, and/or by other suitable devices. Further for explanatory purposes, the blocks (or operations) of the process 1300 are described herein as occurring in serial, or linearly. However, multiple blocks (or operations) of the process 1300 may occur in parallel or concurrently. In addition, the blocks (or operations) of the process 1300 need not be performed in the order shown and/or one or more blocks (or operations) of the process 1300 need not be performed and/or can be replaced by other operations. The process 1300 may be terminated when its operations are completed. In addition, the process 1300 may correspond to a method, a procedure, an algorithm, etc.

The experience analytics server 122 receives, from a first device (e.g., the member client device 102), an indication of user input selecting to perform sentiment analysis with respect to survey response data (block 1302). At block 1304, the experience analytics server 122 accesses, in response to receiving the user input, the survey response data from storage, the survey response data including a respective question and response pair for each of plural questions included within a survey provided to at least one second device (e.g., the customer client device 104).

The experience analytics server 122 determines, using a large language model (e.g., corresponding to one or more neural networks), a sentiment classification for the respective question and response pair for each of the plural questions, the sentiment classification being one of positive sentiment, negative sentiment or neutral sentiment (block 1306). The experience analytics server 122 provides, based on determining the sentiment classification for each of the plural questions, display of sentiment results/metrics on the first device (block 1308).

In example embodiments, for each of the plural questions, the experience analytics server 122 generates a prompt requesting the sentiment classification for the respective question and response pair, provides the prompt to a large language model (e.g., OpenAI's), and receives, from the large language model, the sentiment classification for the respective question and response pair. For example, the prompt is provided to the large language model in a batched manner, for improved efficiency and cost with respect to computational resources.

In example embodiments, the display of the sentiment results/metrics includes display of the respective question and response pair together with its corresponding sentiment classification. For example, the experience analytics server 122 provides, on the first device, a user interface element for modifying the corresponding sentiment classification, and stores the modified sentiment classification in association with the respective question and response pair (e.g., in the database 300 in association with the feedback table 316).

In example embodiments, the display of the sentiment results/metrics includes graphs to show trends of sentiment classifications over time. In another example, the display of the sentiment results/metrics includes display of a interface element which is selectable to filter respective question and response pairs by the positive sentiment, the negative sentiment or the neutral sentiment.

### Machine Architecture

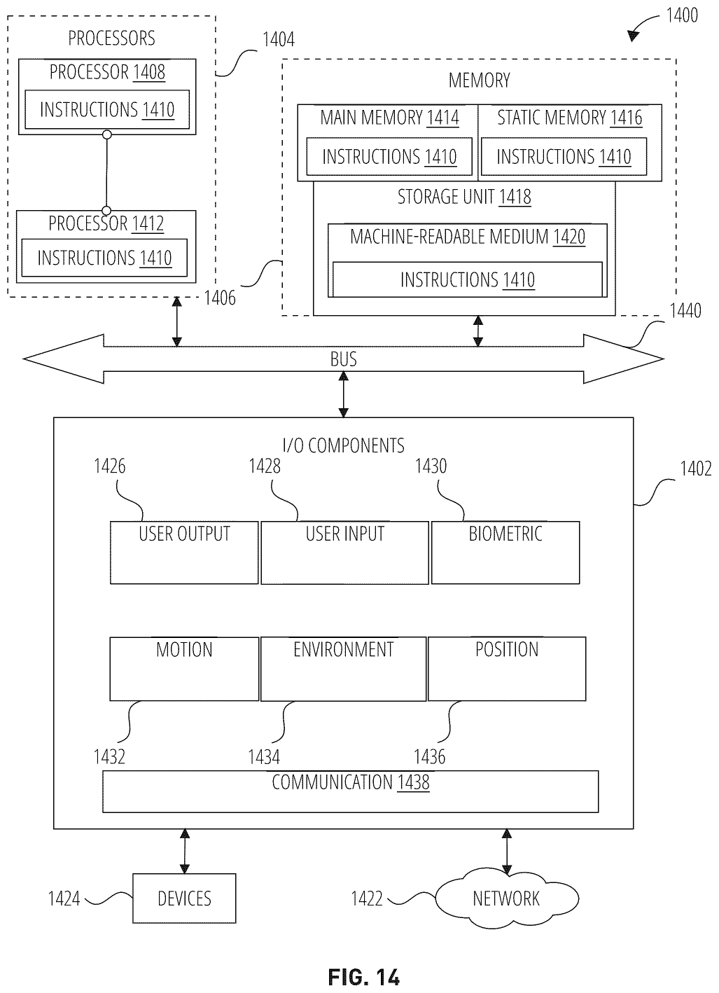

FIG. 14 is a diagrammatic representation of the machine 1400 within which instructions 1410 (e.g., software, a program, an application, an applet, an application, or other executable code) for causing the machine 1400 to perform any one or more of the methodologies discussed herein may be executed. For example, the instructions 1410 may cause the machine 1400 to execute any one or more of the methods described herein. The instructions 1410 transform the general, non-programmed machine 1400 into a particular machine 1400 programmed to carry out the described and illustrated functions in the manner described. The machine 1400 may operate as a standalone device or may be coupled (e.g., networked) to other machines. In a networked deployment, the machine 1400 may operate in the capacity of a server machine or a client machine in a server-client network environment, or as a peer machine in a peer-to-peer (or distributed) network environment. The machine 1400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1410, sequentially or otherwise, that specify actions to be taken by the machine 1400. Further, while only a single machine 1400 is illustrated, the term “machine” shall also be taken to include a collection of machines that individually or jointly execute the instructions 1410 to perform any one or more of the methodologies discussed herein. The machine 1400, for example, may comprise the processors 1404 or any one of a number of server devices forming part of the experience analytics server 122. In some examples, the machine 1400 may also comprise both client and server systems, with certain operations of a particular method or algorithm being performed on the server-side and with certain operations of the particular method or algorithm being performed on the client-side.

The machine 1400 may include processors 1404, memory 1406, and input/output I/O components 1402, which may be configured to communicate with each other via a bus 1440. In an example, the processors 1404 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1408 and a processor 1412 that execute the instructions 1410. The term “processor” is intended to include multi-core processors that may comprise two or more independent processors (sometimes referred to as “cores”) that may execute instructions contemporaneously. Although FIG. 14 shows multiple processors 1404, the machine 1400 may include a single processor with a single-core, a single processor with multiple cores (e.g., a multi-core processor), multiple processors with a single core, multiple processors with multiples cores, or any combination thereof.

The memory 1406 includes a main memory 1414, a static memory 1416, and a storage unit 1418, both accessible to the processors 1404 via the bus 1440. The main memory 1406, the static memory 1416, and storage unit 1418 store the instructions 1410 embodying any one or more of the methodologies or functions described herein. The instructions 1410 may also reside, completely or partially, within the main memory 1414, within the static memory 1416, within machine-readable medium 1420 within the storage unit 1418, within at least one of the processors 1404 (e.g., within the processor's cache memory), or any suitable combination thereof, during execution thereof by the machine 1400.

The I/O components 1402 may include a wide variety of components to receive input, provide output, produce output, transmit information, exchange information, capture measurements, and so on. The specific I/O components 1402 that are included in a particular machine will depend on the type of machine. For example, portable machines such as mobile phones may include a touch input device or other such input mechanisms, while a headless server machine will likely not include such a touch input device. It will be appreciated that the I/O components 1402 may include many other components that are not shown in FIG. 14. In various examples, the I/O components 1402 may include user output components 1426 and user input components 1428. The user output components 1426 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1428 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1402 may include biometric components 1430, motion components 1432, environmental components 1434, or position components 1436, among a wide array of other components. For example, the biometric components 1430 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1432 include acceleration sensor components (e.g., accelerometer), gravitation sensor components, rotation sensor components (e.g., gyroscope).

The environmental components 1434 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the processors 1404 may have a camera system comprising, for example, front cameras on a front surface of the processors 1404 and rear cameras on a rear surface of the processors 1404. The front cameras may, for example, be used to capture still images and video of a user of the processors 1404 (e.g., “selfies”). The rear cameras may, for example, be used to capture still images and videos in a more traditional camera mode. In addition to front and rear cameras, the processors 1404 may also include a 360° camera for capturing 360° photographs and videos.

Further, the camera system of a processors 1404 may include dual rear cameras (e.g., a primary camera as well as a depth-sensing camera), or even triple, quad or penta rear camera configurations on the front and rear sides of the processors 1404. These multiple cameras systems may include a wide camera, an ultra-wide camera, a telephoto camera, a macro camera and a depth sensor, for example.

The position components 1436 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1402 further include communication components 1438 operable to couple the machine 1400 to a network 1422 or devices 1424 via respective coupling or connections. For example, the communication components 1438 may include a network interface component or another suitable device to interface with the network 1422. In further examples, the communication components 1438 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1424 may be another machine or any of a wide variety of peripheral devices (e.g., a peripheral device coupled via a USB).

Moreover, the communication components 1438 may detect identifiers or include components operable to detect identifiers. For example, the communication components 1438 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1438, such as location via Internet Protocol (IP) geolocation, location via Wi-Fi® signal triangulation, location via detecting an NFC beacon signal that may indicate a particular location, and so forth.

The various memories (e.g., main memory 1414, static memory 1416, and memory of the processors 1404) and storage unit 1418 may store one or more sets of instructions and data structures (e.g., software) embodying or used by any one or more of the methodologies or functions described herein. These instructions (e.g., the instructions 1410), when executed by processors 1404, cause various operations to implement the disclosed examples.

The instructions 1410 may be transmitted or received over the network 1422, using a transmission medium, via a network interface device (e.g., a network interface component included in the communication components 1438) and using any one of several well-known transfer protocols (e.g., hypertext transfer protocol (HTTP)). Similarly, the instructions 1410 may be transmitted or received using a transmission medium via a coupling (e.g., a peer-to-peer coupling) to the devices 1424.

### Software Architecture

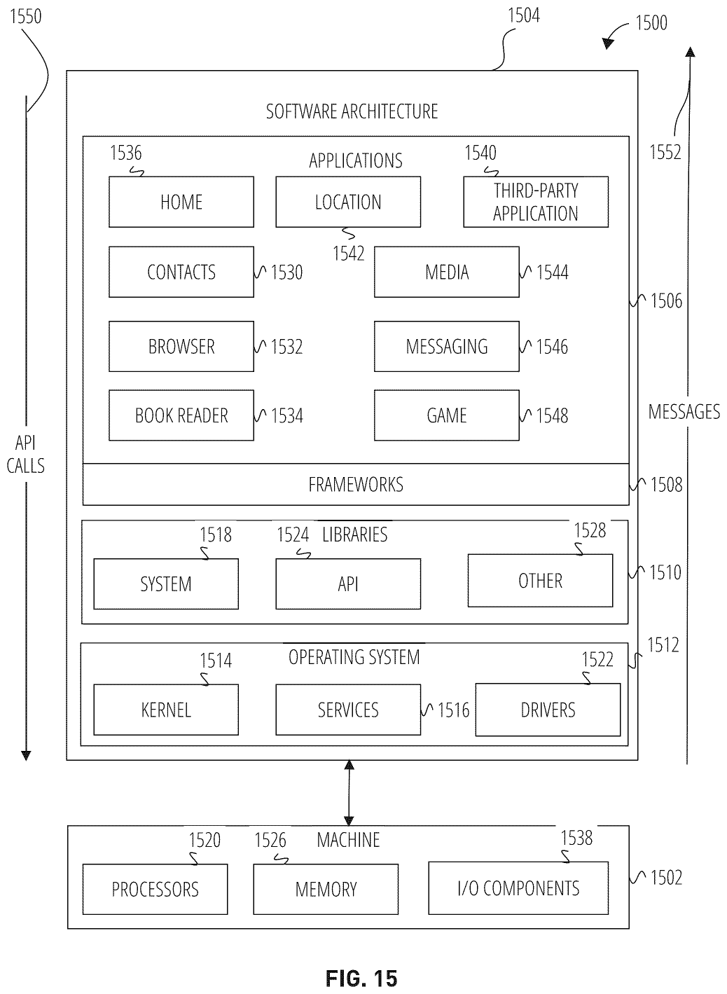

FIG. 15 is a block diagram 1500 illustrating a software architecture 1504, which can be installed on any one or more of the devices described herein. The software architecture 1504 is supported by hardware such as a machine 1502 that includes processors 1520, memory 1526, and I/O components 1538. In this example, the software architecture 1504 can be conceptualized as a stack of layers, where each layer provides a particular functionality. The software architecture 1504 includes layers such as an operating system 1512, libraries 1510, frameworks 1508, and applications 1506. Operationally, the applications 1506 invoke API calls 1550 through the software stack and receive messages 1552 in response to the API calls 1550.

The operating system 1512 manages hardware resources and provides common services. The operating system 1512 includes, for example, a kernel 1514, services 1516, and drivers 1522. The kernel 1514 acts as an abstraction layer between the hardware and the other software layers. For example, the kernel 1514 provides memory management, processor management (e.g., scheduling), component management, networking, and security settings, among other functionality. The services 1516 can provide other common services for the other software layers. The drivers 1522 are responsible for controlling or interfacing with the underlying hardware. For instance, the drivers 1522 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1510 provide a common low-level infrastructure used by the applications 1506. The libraries 1510 can include system libraries 1518 (e.g., C standard library) that provide functions such as memory allocation functions, string manipulation functions, mathematic functions, and the like. In addition, the libraries 1510 can include API libraries 1524 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1510 can also include a wide variety of other libraries 1528 to provide many other APIs to the applications 1506.

The frameworks 1508 provide a common high-level infrastructure that is used by the applications 1506. For example, the frameworks 1508 provide various graphical user interface (GUI) functions, high-level resource management, and high-level location services. The frameworks 1508 can provide a broad spectrum of other APIs that can be used by the applications 1506, some of which may be specific to a particular operating system or platform.

In an example, the applications 1506 may include a home application 1536, a contacts application 1530, a browser application 1532, a book reader application 1534, a location application 1542, a media application 1544, a messaging application 1546, a game application 1548, and a broad assortment of other applications such as a third-party application 1540. The applications 1506 are programs that execute functions defined in the programs. Various programming languages can be employed to create one or more of the applications 1506, structured in a variety of manners, such as object-oriented programming languages (e.g., Objective-C, Java, or C++) or procedural programming languages (e.g., C or assembly language). In a specific example, the third-party application 1540 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1540 can invoke the API calls 1550 provided by the operating system 1512 to facilitate functionality described herein.

### Glossary

“Carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A method, comprising:
receiving, from a first device, an indication of user input selecting to perform sentiment analysis with respect to survey response data;
accessing, in response to receiving the user input, the survey response data from storage, the survey response data including a respective question and response pair for each of plural questions included within a survey provided to at least one second device;
determining, using a large language model, a sentiment classification for the respective question and response pair for each of the plural questions, the sentiment classification being one of positive sentiment, negative sentiment or neutral sentiment; and
providing, based on determining the sentiment classification for each of the plural questions, display of sentiment metrics on the first device.

2. The method of claim 1, further comprising, for each of the plural questions:
generating a prompt requesting the sentiment classification for the respective question and response pair;
providing the prompt to the large language model; and
receiving, from the large language model, the sentiment classification for the respective question and response pair.

3. The method of claim 2, wherein the prompt is provided to the large language model in a batched manner, for improved efficiency and cost with respect to computational resources.

4. The method of claim 1, wherein the display of the sentiment metrics includes display of the respective question and response pair together with its corresponding sentiment classification.

5. The method of claim 4, further comprising:
providing, on the first device, a user interface element for modifying the corresponding sentiment classification; and
storing the modified sentiment classification in association with the respective question and response pair.

6. The method of claim 1, wherein the display of the sentiment metrics includes graphs to show trends of sentiment classifications over time.

7. The method of claim 1, wherein the display of the sentiment metrics includes display of a interface element which is selectable to filter respective question and response pairs by the positive sentiment, the negative sentiment or the neutral sentiment.

8. A system comprising:
at least one processor; and
a memory storing instructions that, when executed by the at least one processor, configure the at least one processor to perform operations comprising:
receiving, from a first device, an indication of user input selecting to perform sentiment analysis with respect to survey response data;
accessing, in response to receiving the user input, the survey response data from storage, the survey response data including a respective question and response pair for each of plural questions included within a survey provided to at least one second device;
determining, using a large language model, a sentiment classification for the respective question and response pair for each of the plural questions, the sentiment classification being one of positive sentiment, negative sentiment or neutral sentiment; and
providing, based on determining the sentiment classification for each of the plural questions, display of sentiment metrics on the first device.

9. The system of claim 8, the operations further comprising, for each of the plural questions:
generating a prompt requesting the sentiment classification for the respective question and response pair;
providing the prompt to the large language model; and
receiving, from the large language model, the sentiment classification for the respective question and response pair.

10. The system of claim 9, wherein the prompt is provided to the large language model in a batched manner, for improved efficiency and cost with respect to computational resources.

11. The system of claim 8, wherein the display of the sentiment metrics includes display of the respective question and response pair together with its corresponding sentiment classification.

12. The system of claim 11, the operations further comprising:
providing, on the first device, a user interface element for modifying the corresponding sentiment classification; and
storing the modified sentiment classification in association with the respective question and response pair.

13. The system of claim 8, wherein the display of the sentiment metrics includes graphs to show trends of sentiment classifications over time.

14. The system of claim 8, wherein the display of the sentiment metrics includes display of a interface element which is selectable to filter respective question and response pairs by the positive sentiment, the negative sentiment or the neutral sentiment.

15. A non-transitory computer-readable storage medium, the computer-readable storage medium including instructions that when executed by a computer, cause the computer to perform operations comprising:
receiving, from a first device, an indication of user input selecting to perform sentiment analysis with respect to survey response data;
accessing, in response to receiving the user input, the survey response data from storage, the survey response data including a respective question and response pair for each of plural questions included within a survey provided to at least one second device;
determining, using a large language model, a sentiment classification for the respective question and response pair for each of the plural questions, the sentiment classification being one of positive sentiment, negative sentiment or neutral sentiment; and
providing, based on determining the sentiment classification for each of the plural questions, display of sentiment metrics on the first device.

16. The non-transitory computer-readable storage medium of claim 15, the operations further comprising, for each of the plural questions:
generating a prompt requesting the sentiment classification for the respective question and response pair;
providing the prompt to the large language model; and
receiving, from the large language model, the sentiment classification for the respective question and response pair.

17. The non-transitory computer-readable storage medium of claim 16, wherein the prompt is provided to the large language model in a batched manner, for improved efficiency and cost with respect to computational resources.

18. The non-transitory computer-readable storage medium of claim 15, wherein the display of the sentiment metrics includes display of the respective question and response pair together with its corresponding sentiment classification.

19. The non-transitory computer-readable storage medium of claim 18, the operations further comprising:
providing, on the first device, a user interface element for modifying the corresponding sentiment classification; and
storing the modified sentiment classification in association with the respective question and response pair.

20. The non-transitory computer-readable storage medium of claim 15, wherein the display of the sentiment metrics includes graphs to show trends of sentiment classifications over time.
